(19) United States
(12) Patent Application Publication
(10) Pub. No.: US 2006/0089281 A1
(43) Pub. Date: Apr. 27, 2006

(54) Methods and compositions for paint removal

(76) Inventor: Gregory L. Gibson, Lexington, KY (US)

Correspondence Address: FROST BROWN TODD, LLC, 2200 PNC CENTER, 201 E. FIFTH STREET, CINCINNATI, OH, 45202, US

(21) Appl. No.: 11/218,070

(22) Filed: Sep. 1, 2005

Related U.S. Application Data
(60) Provisional application No. 60/606,403, filed on Sep. 1, 2004.

(51) Int. Cl. C23D 17/00; C09D 9/00

(52) U.S. Cl. 510/201; 134/38

(57) ABSTRACT

The present invention relates to compositions and their use for removing coatings from a substrate. The present invention is directed to a composition comprising (a) surfactants, (b) a sequestrant, and (c) a plasticizer/solvent. The composition may also contain (d) a hydrolyzing agent, e.g., a strong base compound and other additives. The composition of the present invention is free of chlorinated solvents, environmentally safe and user-friendly. In one embodiment, the composition further comprises a hydrolyzing agent present in an amount sufficient to reduce at least one of mechanical strength and adhesion between the coating and the substrate. Another embodiment of the invention is a method for removing paint or a coating from a substrate comprising applying a paint or coating removing effective amount of a composition comprising the compositions described herein to the substrate. Yet another embodiment of the invention is a method for cleaning a substrate comprising applying a cleaning effective amount of the composition of the present invention to the substrate. In one particular embodiment of the present invention, an immersion method for the removal of cured and uncured paint and coatings from ferrous metals is provided.

### CROSS REFERENCE TO RELATED APPLICATIONS

This application claims priority under 35 U.S.C. 119 to U.S. provisional application Ser. No. 60/606,403, filed Sep. 1, 2004, and entitled “METHODS AND COMPOSITIONS FOR PAINT REMOVAL” the disclosure of which is hereby expressly incorporated herein by reference.

### FIELD OF THE INVENTION

The present invention relates to compositions and their use for removing coatings from a substrate. The composition may include a surfactant, a sequestrant, and a plasticizer/solvent. The composition may also contain a hydrolyzing agent, e.g., a strong base compound. The composition may be used in a process for removing paint by applying it to a painted surface.

### BACKGROUND OF THE INVENTION

Historically, there have been a number of commercial products and processes available for paint removal ranging from furniture and wood restoration to OEM automotive and aerospace production requirements. In particular, certain OEM production pieces with paint build-ups are desired to be re-used, parts with paint defects are desired to be recovered and finally paint over-spray build-ups require cleaning methodology.

Previously, the preferred and lowest cost methods involved immersion processes utilizing alkaline (caustic) baths both hot and cold, chlorinated solvent baths, and ketone/aromatic/aliphatic/glycol ether/dibasic-ester/alcohol/pyrole/sulfoxide baths (flammable solvent) for fast effective paint removal on substrates known to be unaffected by the removal medium.

Unfortunately, caustic systems when saturated via organic digestion in the stripping process produce a hazardous waste stream and present an obvious worker hazard, chlorinated solvents produce a hazardous waste stream when saturated and are known carcinogens and finally other utilized organic liquids shown to be effective are either flammable, worker health risks, environmental risks, produce hazardous waste streams or are too expensive to be economically viable processes.

Finally, an increase in alternative paint removal processes gave way to physical removal methods including pyrolisis (burn-off), fluidized media at both ambient and elevated temps, CO₂ blasting, ultra-high pressure water blasting, molten salt baths and shot blasting in the last 10 to 15 years for commercial applications. These processes were intended to have less environmental impact and remove the worker to some extent from the process. Additionally, these processes are more capital investment intensive, have higher running operating costs and finally are not suitable to all part substrates (melts or warps part) or causes damage or abrasion wear to parts on a recycling service schedule.

Therefore, there is a need to provide the best possible alternative commercial application to develop methodology that achieved the prior low cost standard, does not produce or at least minimizes hazardous waste generation, is not carcinogenic, keeps capital investment requirements to a minimum, has process cycle times and performance efficacies that would be commercially acceptable to targeted customers and applications and finally that protects the substrates and parts being processed without resultant damage from the process.

There is also a continuing need for compositions that clean polymeric substrates, such as polyacrylate and polycarbonate substrates, without damaging the substrates. There is also a need for a composition that is low cost, utilizes existing customer processes and does not generate a hazardous waste stream.

### BRIEF SUMMARY OF THE INVENTION

The present invention relates to compositions and their use for removing coatings from a substrate. The present invention is directed to a composition comprising (a) surfactants, (b) a sequestrant, and (c) a plasticizer/solvent. The composition may also contain (d) a hydrolyzing agent, e.g., a strong base compound and other additives. The composition of the present invention is free of chlorinated solvents, environmentally safe and user-friendly.

In one embodiment, the composition further comprises a hydrolyzing agent present in an amount sufficient to reduce at least one of mechanical strength and adhesion between the coating and the substrate, wherein the hydrolyzing agent is a strong base selected from the group consisting of sodium hydroxide, potassium hydroxide, trisodium phosphate, disodium phosphate, and mixtures thereof.

The total concentration of hydrolyzing agent in solution is that sufficient to achieve attack and break down of the targeted chemical bonds so as to reduce the mechanical strength of the bond between the coating and the substrate, with concentrations between about 1% and about 50% by weight being preferred. In the process of the present invention, hydrolyzing agent is present in a concentration preferably between about 2% and about 25% by weight.

Another embodiment of the invention is a method for removing paint or a coating from a substrate comprising applying a paint or coating removing effective amount of a composition comprising the compositions described herein to the substrate.

Yet another embodiment of the invention is a method for cleaning a substrate comprising applying a cleaning effective amount of the composition of the present invention to the substrate.

In one embodiment, the present invention provides for methods for removing paint based on specific innovations.

In one embodiment, the present invention provides for an immersion method for the removal of cured and uncured paint and coatings from ferrous metals.

In another embodiment, the present invention provides for an immersion method for the removal of cured and uncured paints and coatings from non-ferrous metals and light alloys.

In another embodiment, the present invention provides for an immersion method for the removal of cured paints and coatings from polymeric substrates.

Preferably, the polymeric substrate is one or more of the polymers selected from the group consisting of epoxies, fluorinated resins, polyamides, polyesters, rayon, silicone resins, synthetic and natural rubbers, urethanes and mixtures thereof.

In one particular embodiment of the present invention, an immersion method for the removal of cured and uncured paint and coatings from ferrous metals is provided.

Without wishing to be bound by theory in any way, the present invention provides methods of using very specific blends of surfactants are utilized that initially penetrate and expand the macromolecular lattice for cured and uncured coating particles (or help to create and release particles out of existing cross-linked films) following the surface adsorption and alignment of additional surfactants onto the released “organic particle,” thereby constituting the formation of a stable micelle. The resulting micelle nucleus (“organic particle”), being effectively isolated from the bulk paint removal bath or solution. The surfactants utilized include, but are not limited to, alcohol ethoxylates (linear and branched), nonylphenols, betaines, phosphate esters, alpha-olefin sulfonates, sulfates of alcohol ethoylates, sodium and ammonium lauryl sulphates, imadazolines, polyglycosides and various alcohols.

Again, without wishing to be bound by theory in any way, the present invention provides methods of using surfactants with specific surface activities required to form the “micelles” (insoluble soft particles surface coated with surfactant (s) that are made soluble via surfactant adsorption). Therefore, one set of surfactants in the formulation are utilized in releasing (creating) the particles from the contiguous organic coating film as the caustic media breaks bonds creating fragments; and with other surfactants present in the compound, adsorption commences. Secondarily, the additional surfactants coat the other exposed interfaces including the exposed substrate, paint removal vessel wall interface and the liquid-liquid and liquid-air interfaces associated with the multi-phase system and atmospheric contact interface, according to their “normal” electrochemical affinities. This is essentially achieved by utilizing hydrophobic surfactants in the formulation, made marginally soluble with a co-surfactant whereby affinity preference will align on the organic coating departing the bulk phase of solution; as soon as an “adsorption” site becomes available in the presence of the surfactant molecule as promoted and effected via the penetration, swelling & bond breaking activities in the system. The result is a “protected” organic particle that is somewhat resistant to further digestion and hence will not substantially contribute to an increase in dissolved solids for the bulk solution.

In addition, the activity and mechanism of penetrating through the organic film to be removed, all the way to the organic cross linked adhesion—e.g., ferrous metal interface. The surfactant(s) leaves pathways behind them as they penetrate for plasticizers (e.g., alcohols & glycol ethers) and sequestrates to be pulled into the lattice behind the wetting agents.” Whereby, the sequestrates break down adhesive charges and bonds at the ferrous interface and give way to surface adsorption by “other” surfactants and the plasticizers act to “swell” and soften the film thereby accelerating digestion and particle generation.

Therefore, for methods dealing with ferrous metal substrates, the present invention provides for surfactant(s) and groups of surfactants functioning as (1) lattice penetrating surfactants; (2) solubilizing and equillibria controlling co-surfactants; (3) accelerators of organic particle formation; (4) micelle formers; and (5) ferrous metal and other metallic substrate adsorbers.

In general, the surfactants that are useful in the present invention are alcohol ethoxylates (linear and branched), nonylphenols, betaines, phosphate esters, alpha-olefin sulfonates, sulfates of alcohol ethoylates, sodium and ammonium lauryl sulphates, imadazolines, polyglycosides and various alcohols.

Specifically, C9-C11 with 2.5 moles of EO, commercially known as Tomadol 91-2.5 (Ethoxylated 2,4,7,9-tetramethyl 5 decyn-4, 7 Diol CAS No. 9014-85-1) is a preferred coating penetrant. Other low mole EO ethoxylated alcohols (linear & branched) commercially available will work, preferably at 4 moles of EO or less and more preferably at 4 moles of EO or less. Preferably, the alcohol chain length is about C15 or less in length. Preferably, the non-ionic surfactant is selected from the group consisting of Pluronic L62, Pluronic L43, Tomadol 23-3, Tomadol 91-2.5, and Tomadol 1-5.

In one specific embodiment, the present invention provides for a composition comprising:

a. from about 1 to about 45 wt. % (at final bath concentration) of a surfactant;

b. from about 1 to 15 wt. % of a solvent; and

c. from about 1 to about 98 wt. % of an alkalinity source.

Optionally, the composition contains one or more of the following:

d. from about Ito about 10 wt. % of a sequestrant;

e. from about 0 to about 15 wt. % of an alcohol;

f. from about 1 to 15 wt. % of a water-soluble plasticizer;

g. from about 0 to about 5 wt. % of a re-deposition inhibitor; and

h. other additives

In another specific embodiment, the present invention provides for a composition comprising:

a. from about 1 to about 45 wt. % (at final bath concentration) of a stripping agent;

b. from about 1 to 15 wt. % of a solvent; and

c. from about 1 to about 95 wt. % of an alkalinity source.

wherein the stripping agent comprises a surfactant, a sequestrant, an alcohol, a water-soluble plasticizer, a re-deposition inhibitor, an alkalinity source and mixtures thereof;

and wherein the surfactant comprises:

1. Surfactant A: Penetration of the organic coating

2. Surfactant B: Organic Particle formation

3. Surfactant C: Surface adsorption

The ratio of surfactants A:B:C is about 1:5:3, for penetrating wetters/particle formers:soft particle adsorbers:metallic surface adsorbers.

Preferably, the surfactant is selected from the group consisting of alcohol ethoxylates (linear and branched), nonylphenols, betaines, phosphate esters, alpha-olefin sulfonates, sulfates of alcohol ethoylates, sodium and ammonium lauryl sulphates, imadazolines, polyglycosides and various alcohols or is selected from C6 to C15 ethoxylated alcohols with an ethoxylation with 2 to 4 moles of ethylene oxide per R—OH].

Preferably, the plasticizer has a boiling point of at least about 100 to about 250° C., is capable of “swelling” and plasticizing cured coatings; and is selected from the group consisting of glycol, glycol ether, high boiling point ketone (e.g., di-acetone alcohol) or long-chain alcohol (from about C1 to about C15 alcohol). More preferably, the plasticizer is selected form the group ethylene glycol ether, diethylene glycol ether, propylene glycol ether, dipropylene glycol ether, diethylene glycol monomethyl ether, dipropylene glycol methyl ether, dipropylene glycol normal propyl ether, or mixtures thereof.

In another specific embodiment, the present invention provides for a composition comprising:
a. from about 1 to about 30 wt. % (at final bath concentration) of a surfactant;
b. from about 1 to about 20 wt. % of a sequestrant; and
c. from about 1 to about 15 wt. % of a water-soluble plasticizer;

In another embodiment, the composition further comprises (d) from about 1 to about 95 wt. % of a hydrolyzing agent.

In another embodiment, the composition further comprises from about 2 to about 5 wt. % of an alcohol. In yet another embodiment, the composition further comprises from about 1 to about 2.5 wt. % of a re-deposition inhibitor.

Preferably, the surfactant is preferably a mixture of surfactants, since different activities with respect to different functions/mechanisms involved with the individual surfactants takes place all within one formulation:
1. Surfactant A: Preferably, one or more surfactants selected from the group consisting of Low Moiety EO nonionics, ethoxylated diols types, phosphate esters and R-propionic acid monosodium salts
2. Surfactant B: Preferably, one or more surfactants selected from the group consisting of nionics and nonionics as a co-surfactant.
3. Surfactant C: Preferably, one or more surfactants selected from the group consisting of Amphoterics, ethoxylated diols types and High Moiety EO Nonionics.

In another specific embodiment, the present invention provides for a composition comprising:

a. from about 2.5 to about 15 wt. % (at final bath concentration) of a surfactant;

b. from about 1 to about 2 wt. % of a sequestrant;

c. from about 5 to 7 wt. % of a water-soluble plasticizer; and

d. from about 1 to about 2.5 wt. % of a re-deposition inhibitor.

In another embodiment, the composition further comprises (d) from about 1 to about 95 wt. % of a hydrolyzing agent. In another embodiment, the composition further comprises from about 1 to about 15 wt. % of an alcohol. Preferably, the alcohol is a branched or linear alcohol of less than about C15, C14, C13, C12, C11, C10 or less.

In another specific embodiment, the present invention provides for a composition comprising:

a. from about 2.5 to about 15 wt. % (at final bath concentration) of a surfactant;

b. from about 1 to about 30 wt. % of a sequestrant;

c. from about 2 to about 25 wt. % of an alcohol;

d. from about 5 to 1 wt. % of a water-soluble plasticizer; and

e. from about 1 to about 5 wt. % of a re-deposition inhibitor.

In another embodiment, the composition further comprises (d) from about 1 to about 95 wt. % of a hydrolyzing agent. In another embodiment, the composition further comprises from about 1 to about 15 wt. % of an alcohol.

In another specific embodiment, the present invention provides for a composition comprising:

a. from about 2 to about 45 wt. % (at final bath concentration) of a surfactant;

b. from about 1 to about 2 wt. % of a sequestrant;

c. from about 2 to about 5 wt. % of an alcohol;

d. from about 5 to about 15 wt. % of a water-soluble plasticizer;

e. from about 1 to about 5 wt. % of a re-deposition inhibitor; and

f. from about 1 to about 95 wt. % of an alkalinity source.

Generally, the water soluble plasticizer is a glycol ether due to their miscibility with water, relatively high boiling point, relatively high flash point and their demonstrated performance in “swelling” and plasticizing cured coatings. Preferably, the glycol ether is ethylene glycol ether, diethylene glycol ether, propylene glycol ether, dipropylene glycol ether, diethylene glycol monomethyl ether, dipropylene glycol methyl ether, dipropylene glycol normal propyl ether, or mixtures thereof.

In one particular embodiment of the present invention, an immersion method for the removal of cured paints and coatings from polymeric substrates is provided. The present invention provides for a low cost, recovered raw material content of molded thermoplastic parts in granule form for remolding and/or recovered whole parts to be returned for repainting and the resulting productivity gain in the molding process due to scrap as a result of unacceptable paint defects. The basic technology developed can best be characterized as surface selective emulsion de-polymerization via surface active induced adhesive failure of organic coatings on polymeric substrates. This invention is particularly effective on nylons, TPO (polyolefins and rubber modified polyolefins), HDPE, LDPE, polycarbonates, olypropylene (PP) and polyvinyl chloride (PVC).

The present invention provides for the use of specific surfactants, when used in combination in the presence of other supporting systems and catalysts, that have the ability to penetrate and migrate to a specific solid-solid interface, that can displace certain interfaces and surface coat between an existing adhesive bond and substrates under specific conditions and finally can selectively differentiate between similar solid macromolecular chemistries in terms of associated surface energies of a substrate; which ultimately determines whether or not the surfactant(s) will penetrate or surface coat at a given interface.

This technology is similar in its approach to the formation of isolated organic nuclei particle micelles via the use of pre-engineered surface active effects. Preferably, in this case little or no physical mechanisms are employed to release, create or coat particles.

The specific blends of surfactants are utilized that initially penetrate and expand the macromolecular lattice for cured (cross-linked) films. Following surface adsorption, penetration and alignment of surfactants onto the solid-solid interface, adhesion is fundamentally disrupted. The surfactants utilized but are not limited to alcohol ethoxylates (linear and branched), nonylphenols, betaines, phosphate esters, alpha-olefin sulfonates, sulfates of alcohol ethoylates, sodium and ammonium lauryl sulphates, imadazolines, polyglycosides and various alcohols.

The blends of surfactants, sequestrants, alcohols and glycol ethers are utilized to penetrate, swell and expand the macromolecular lattice and finally exhibit a strong electrochemical affinity for surface migration and coating to the solid-solid interface; thus defeating and competing with the coating adhesion mechanism(s) of the previously adhered film.

In one preferred embodiment, the surfactants utilized are alkaline stable at a pH greater than about 10, 11, 12, 13, 13.5 or more, at elevated temperatures up to about 110° C. or more for several days.

To utilize an aqueous alkaline (caustic) medium intended to de-polymerize (break bonds and chains) the macromolecular lattice via attack upon ester and ether bonds of organic resins and elastomers, as present in the coating. The resulting hydronium ion (OH—), based on a controlled equillibria Ksp, to have limited access to the interior of the lattice by absorption of the bulk media during the swelling process, but having a limited contact time until the formation of the subsequent micelle.

Time and temperature effect the processing as the typical molding grade of polymeric material expands at elevated temperatures and has the potential to absorb contaminating elements into the resin from the bulk solution, as the surfactant coating systems cannot completely inhibit expanded lattice absorption for immersion times in excess of about 20 to 120 minutes. Absorption of alkali compounds, surfactants and other co-solvents from the system can have a deleterious effect on resin performance over time, overall paint adhesion and compatibility if re-painted, degradation over time of polymer chains within the lattice, oxidation of compounded stabilizers and anti-oxidants and a general degradation of physical properties of the resin as compared to “un-processed” material. Therefore, limiting process immersion times to less than about 120, 90, 60, 50, 45, 30, 25, 20, 15, 12, or 10 minutes or less effects the long term performance of the resin. Removal by mechanical means and surface cleaning are preferably completed less than about 120, 90, 60, 50, 45, 30, 25, 20, 15, 12, or 10 minutes or less in order to avoid re-deposition and/or re-adhesion due to weakening imparted surface energies from the immersion step. The resulting cleaned resin substrate is suitable for re-use, re-painting or to be granulated for re-molding. Preferably, the process does not expose the resin substrate to high heat history or excessive shear conditions that will further degrade the physical properties of the resin.

In one embodiment, the invention relates in general to processes for recycling thermoplastic material. This invention also relates to processes for rendering scrap thermoplastic suitable for reprocessing and reuse. More particularly, the present invention relates to a method for removing deleterious surfaces such as paint, UV oxidation, etc. from particulate thermoplastic material.

In the present invention, it is preferred that the process proceeds until any residual coating retained on the substrate at the end of the process is very small.

The compositions of the invention unexpectedly exhibit excellent coating removal activity far exceeding that action exhibited by either the surfactant or plasticizer component alone at equivalent or equal concentration.

The above summary of the present invention is not intended to describe each embodiment or every implementation of the present invention. Advantages and attainments, together with a more complete understanding of the invention, will become apparent and appreciated by referring to the following detailed description and claims.

Further aspects and advantages of this invention will be disclosed in the following examples, which should be regarded as illustrative and not limiting the scope of this application.

### DETAILED DESCRIPTION OF THE INVENTION

One skilled in the art will readily appreciate that the present invention is well adapted to carry out the objects and obtain the ends and advantages mentioned as well as those inherent therein. It should be understood, however, that the materials, compounds, coatings, methods, procedures, and techniques described herein are presently representative of preferred embodiments. These techniques are intended to be exemplary, are given by way of illustration only, and are not intended as limitations on the scope. Other objects, features, and advantages of the present invention will be readily apparent to one skilled in the art from the following detailed description; specific examples and claims; and various changes, substitutions, other uses and modifications that may be made to the invention disclosed herein without departing from the scope and spirit of the invention or as defined by the scope of the appended claims.

As used herein other than the claims, the terms “a,” “an,” “the,” and “the” means one or more. As used herein in the claim(s), when used in conjunction with the words “comprises” or “comprising,” the words “a” “the,” or “the” may mean one or more than one. As used herein “another” may mean at least a second or more.

As would be known to one of ordinary skill in the art, many variations of nomenclature are commonly used to refer to a specific chemical composition. Accordingly, several common alternative names may be provided herein in quotations and parentheses/brackets, or other grammatical technique, adjacent to a chemical composition's preferred designation when referred to herein. Additionally, many chemical compositions referred to herein are further identified by a Chemical Abstracts Service registration number. As would be known to those of ordinary skill in the art, the Chemical Abstracts Service provides a unique numeric designation, denoted herein as “CAS No.,” for specific chemicals and some chemical mixtures, which unambiguously identifies a chemical composition's molecular structure.

In various embodiments described herein, exemplary values are specified as a range. It will be understood that herein the phrase “including all intermediate ranges and combinations thereof” associated with a given range is all integers and sub-ranges comprised within a cited range. For example, citation of a range “0.03% to 0.07%, including all intermediate ranges and combinations thereof is specific values within the sited range, such as, for example, 0.03%, 0.04%, 0.05%, 0.06%, and 0.07%, as well as various combinations of such specific values, such as, for example, 0.03%, 0.06% and 0.07%, 0.04% and 0.06%, or 0.05% and 0.07%, as well as sub-ranges such as 0.03% to 0.05%, 0.04% to 0.07%, or 0.04% to 0.06%, etc.

Amounts of ingredients stated herein generally refer to the amount of the particular active ingredient (e.g., surfactant). Amounts stated for commercial products typically relate to the amount of the commercial product. The amount of active provided by the commercial product can be determined from the concentration of the commercial product and the fraction of the commercial product that is the active ingredient.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use compositions in the real world; through inadvertent error in these procedures; through differences in the manufacture, source, or purity of the ingredients employed to make the compositions or carry out the methods; and the like. Whether or not modified by the term “about”, it is intended that the claims include equivalents to the quantities.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods, devices, and materials are now described. All references, publications, patents, patent applications, and commercial materials mentioned herein are incorporated herein by reference for the purpose of describing and disclosing the cell lines, vectors, and methodologies which are reported in the publications which might be used in connection with the invention. Nothing herein is to be construed as an admission that the invention is not entitled to antedate such disclosure by virtue of prior invention.

In order to provide a clear and consistent understanding of the specification and claims, including the scope to be given such terms, the following definitions are provided:

An “alcohol” comprises an alcohol moiety. The alcohol moiety confers miscibility with water. Consequentially, increasing molecular size of an alcohol comprising a single alcohol moiety generally reduces miscibility with water. Alcohols typically possess a mild and/or pleasant odor. An alcohol is typically a poor primary solvent, though ethanol is an exception relative to a solute comprising a phenolic and/or polyvinyl resin. An alcohol may be selected as a latent solvent, co-solvent, a coupling solvent, a diluent, or combination thereof such as with solute comprising a nitrocellulose lacquer, melamine-formaldehyde, urea formaldehyde, alkyd, or combination thereof. Examples of an alcohol include methanol (CAS No. 67-56-1); ethanol (CAS No. 64-17-5); propanol (CAS No. 71-23-8); isopropanol (CAS No. 67-63-0); 1-butanol (CAS No. 71-36-3); isobutanol (CAS No. 78-83-1); 2-butanol (CAS No. 78-92-2); tert-butanol (CAS No. 75-65-0); amyl alcohol (CAS No. 71-41-0); isoamyl alcohol (123-51-3); hexanol (25917-35-5); methylisobutylcarbinol (CAS No. 108-11-2); 2-ethylbutanol (CAS No. 97-95-0); isooctyl alcohol (CAS No. 26952-21-6); 2-ethylhexanol (CAS No. 104-76-7); isodecanol (CAS No. 25339-17-7); cylcohexanol (CAS No. 108-93-0); methylcyclohexanol (CAS No. 583-59-5); trimethylcyclohexanol; benzyl alcohol (CAS No. 100-51-6); methylbenzyl alcohol (CAS No. 98-85-1); furfuryl alcohol (CAS No. 98-00-0); tetrahydrofurfuryl alcohol (CAS No. 97-99-4); diacetone alcohol (CAS No. 123-42-2); trimethylcyclohexanol (116-02-9); or a combination thereof. Furfuryl alcohol and tetrahydrofurfuryl alcohol may be selected as a primary solvent for a polyvinyl binder. Examples of an azeotrope comprising an alcohol include an azeotrope comprising butanol, ethanol, isobutanol, or methanol. Examples of an azeotrope comprising a majority of butanol (BP 117.7° C.) include those comprising 97% butanol and 3% hexane (A-BP 67° C.); 32% p-xylene (A-BP 115.7° C.); 32.8% butyl acetate (A-BP 117.6° C.); 44.5% water (A-BP 93° C.); or 50% isobutyl acetate (A-BP 114.5° C.). Examples of an azeotrope comprising a majority of ethanol (BP 78.3° C.) include those comprising 4.4% water (A-BP 78.2° C.); or 32% toluene (A-BP 76.7° C.). Examples of an azeotrope comprising a majority of isobutanol (BP 107.7° C.) include those comprising 2.5% hexane (A-BP 68.3° C.); 5% isobutyl acetate (A-BP 107.6° C.); 17% p-xylene (A-BP 107.5° C.); 33.2% water (A-BP 89.9° C.); or 48% butyl acetate (A-BP 80.1° C.). An example of an azeotrope comprising a majority of methanol (BP 64.6° C.) includes an azeotrope comprising 30% methyl ethyl ketone (A-BP 63.5° C.).

The term “coating” as used herein is generally defined as materials existing on, at, or proximate to the surface of the substrate which, if left in place, would interfere with the reprocessing procedures or with the ultimate performance of the reprocessed material. The coatings may include chemical coating materials imparted during original production processes that are attached to or overlay at least a portion of the surface of the substrate. Examples of these typically include paints, lacquers and various adhesives or bonding agents. Coatings may also consist of surface modification agents such as adhesion modifiers which are present in the outermost region of the substrate. The coating may also be the result of physical changes in the surface regions of the original material such as cross-linking as a result of corona discharge treatment, plasma discharge treatment, and the like. Such physical changes can also be the result of natural processes that occur during the useful life of the substrate such as UV degradation and the like. Paints that can be effectively removed by the process of the present invention include, but are not limited to, various cross-linked paint materials such as thermosetting or UV-curing paints in which the primary binder is polyester or polyacrylate cross-linked with a suitable cross linking agent such as a urethane-based material; such as hexamethylene diisocyanate or various melamine formaldehydes. The removal of non-cross-linked, air drying paints is also considered within the scope of this invention.

An “ester” may comprise an alkyl acetate, an alkyl propionate, a glycol ether acetate, or a combination thereof. An ester generally possesses a pleasant odor.

In general embodiments, an ester possesses a solubility property that decreases with increasing molecular weight. A glycol ester acetate typically possesses a slow evaporation rate. Examples of an ester include methyl formate (CAS No. 107-31-3); ethyl formate (CAS No. 109-94-4); butyl formate (CAS No. 592-84-7); isobutyl formate (CAS No. 542-55-2); methyl acetate (CAS No. 79-20-9); ethyl acetate (CAS No. 141-78-6); propyl acetate (CAS No. 109-60-4); isopropyl acetate (CAS No. 108-21-4); butyl acetate (CAS No. CAS-No. 123-86-4); isobutyl acetate (CAS No. 110-19-0); sec-butyl acetate (CAS No. 105-46-4); amyl acetate (CAS No. 628-63-7); isoamyl acetate (CAS No. 123-92-2); hexyl acetate (CAS No. 142-92-7); cyclohexyl acetate (CAS No. 622-45-7); benzyl acetate (CAS No. 140-11-4); methyl glycol acetate (CAS No. 110-49-6); ethyl glycol acetate (CAS No. 111-15-9); butyl glycol acetate (CAS No. 112-07-2); ethyl diglycol acetate (CAS No. 111-90-0); butyl diglycol acetate (CAS No. 124-17-4); 1-methoxypropyl acetate (CAS No. 108-65-6); ethoxypropyl acetate (CAS No. 54839-24-6); 3-methoxybutyl acetate (CAS No. 4435-53-4); ethyl 3-ethoxypropionate (CAS No. 763-69-9); isobutyl isobutyrate (CAS No. 97-85-8); ethyl lactate (CAS No. 97-64-3); butyl lactate (CAS No. 138-22-7); butyl glycolate (CAS No. 7397-62-8); dimethyl adipate (CAS No. 627-93-0); glutarate (CAS No. 119-40-0); succinate (CAS No. 106-65-0); ethylene carbonate (CAS No. 96-49-1); propylene carbonate (CAS No. 108-32-7); butyrolactone (CAS No. 96-48-0); or a combination thereof. Ethylene carbonate and propylene carbonate generally possess a high flash point, a slow evaporation rate, a weak odor, or a combination thereof. Ethylene carbonate is preferred for use in coatings at temperatures greater than 25° C. Examples of an azeotrope comprising an ester include an azeotrope comprising butyl acetate, ethyl acetate or methyl acetate. Examples of an azeotrope comprising a majority of butyl acetate (BP 124° C. to 128° C.) include those comprising 27% water (A-BP 90.7° C.) or 35.7% ethyl glycol (A-BP 125.8° C.). Examples of an azeotrope comprising a majority of ethyl acetate (BP 76° C. to 77° C.) include those comprising 5% cyclohexanol (A-BP 153.8° C.); 8.2% water (A-BP 70.4° C.); 22% methyl ethyl ketone (A-BP 76.7° C.); 23% isopropyl alcohol (A-BP 74.8° C.); or 31% ethanol (A-BP 71.8° C.). An example of an azeotrope comprising a majority of methyl acetate (BP 55.0° C.-57.0° C.) includes an azeotrope comprising 19% methanol (A-BP 54° C.).

Examples of an ether include diethyl ether (CAS No. 60-29-7); diisopropyl ether (CAS No. 108-20-3); dibutyl ether (CAS No. 142-96-1); di-sec-butyl ether (CAS No. 6863-58-7); methyl tert-butyl ether (CAS No. 1634-04-4); tetrahydrofuran (CAS No. 109-99-9); 1,4-dioxane (CAS No. 123-91-1); metadioxane (CAS No. 505-22-6); or a combination thereof. Tetrahydrofuran may be selected as a primary solvent for a polyvinyl binder. An example of an azeotrope comprising an ether includes an azeotrope comprising tetrahydrofuran. An example of an azeotrope comprising a majority of tetrahydrofuran (BP 66° C.) includes an azeotrope comprising 5.3% water (A-BP 64.0° C.).

A “glycol ether” comprises an alcohol moiety and an ether moiety. The glycol ether generally possesses good solvency, high flash point, slow evaporation rate, mild odor, miscibility with water, or a combination thereof. Examples of a glycol ether include methyl glycol (CAS No. 109-86-4); ethyl glycol (CAS No. 110-80-5); propyl glycol (CAS No. 2807-30-9); isopropyl glycol (CAS No. 109-59-1); butyl glycol (CAS No. 111-76-2); methyl diglycol (111-77-3); ethyl diglycol (CAS No. 111-90-0); butyl diglycol (CAS No. 112-34-5); ethyl triglycol (CAS No. 112-50-5); butyl triglycol (CAS No. 143-22-6); diethylene glycol dimethyl ether (CAS No. 111-96-6); methoxypropanol (CAS No. 107-98-2); isobutoxypropanol (CAS No. 23436-19-3); isobutyl glycol (CAS No. 4439-24-1); propylene glycol monoethyl ether (CAS No. 52125-53-8); 1-isopropoxy-2-propanol (CAS No. 3944-36-3); propylene glycol mono-n-propyl ether (CAS No. 30136-13-1); propylene glycol n-butyl ether (CAS No. 5131-66-8); methyl dipropylene glycol (CAS No. 34590-94-8); methoxybutanol (CAS No. 30677-36-2); or a combination thereof. An example of an azeotrope comprising a glycol ether includes an azeotrope comprising ethyl glycol. An example of an azeotrope comprising a majority of ethyl glycol (BP 134° C. to 137° C.) includes an azeotrope comprising 50% dibutyl ether (A-BP 127° C.).

A “ketone” comprises a ketone moiety. A ketone generally possesses some miscibility with water, and a strong odor. Examples of a ketone include acetone (CAS No. 67-64-1); methyl ethyl ketone (CAS No. 78-93-3); methyl propyl ketone (CAS No. 107-87-9); methyl isopropyl ketone (CAS No. 563-80-4); methyl butyl ketone (CAS No. 591-78-6); methyl isobutyl ketone (CAS No. 108-10-1); methyl amyl ketone (CAS No. 110-43-0); methyl isoamyl ketone (CAS No. 110-12-3); diethyl ketone (CAS No. 96-22-0); ethyl amyl ketone (CAS No. 541-85-5); dipropyl ketone (CAS No. 110-43-0); diisopropyl ketone (CAS No. 565-80-0); cyclohexanone (CAS No. 108-94-1); methylcylcohexanone (CAS No. 1331-22-2); trimethylcyclohexanone (CAS No. 873-94-9); mesityl oxide (CAS No. 141-79-7); diisobutyl ketone (CAS No. 108-83-8); isophorone (CAS No. 78-59-1); or a combination thereof.

An oxygenated compound (“oxygenated liquid compound”) is typically chemically synthesized by standard chemical manufacturing techniques. As a consequence, an individual oxygenated compound is typically an extremely homogenous chemical composition, with singular, rather than a range of, chemical and physical properties. The oxygen moiety of an oxygenated compound generally enhances the strength and breadth of solvency for potential solutes relative to a hydrocarbon. Additionally, an oxygenated compound typically has some or complete miscibility with water. Examples of an oxygenated compound include an alcohol, an ester, a glycol ether, a ketone, or a combination thereof. As would be known to one of ordinary skill in the art, a liquid component often comprises a combination of an alcohol, an ester, a glycol ether, a ketone and/or an addition liquid to produce suitable chemical and/or physical properties.

A “plasticizer” is a compound that confers specific properties to a composition including, for example, enhancing a flow property of a composition, lowering a film-forming temperature range, enhancing the adhesion property, lowering the Tg, or a combination thereof. In certain aspects, a plasticizer may function as a solvent, thinner, diluent, plasticizer, or combination thereof, for a composition at a temperature greater than ambient conditions. A plasticizer typically will lower the Tg of a binder below the temperature a coating comprising the binder will be applied to a surface. In many embodiments, a plasticizer have a vapor pressure less than 3 mm at 200° C., a mass of 200 Da to 800 Da, a specific gravity of 0.75 to 1.35, a viscosity of 50 cSt to 450 cSt, a flash point temperature greater than 120° C., or a combination thereof. Preferred plasticizers comprise an organic liquid (e.g., an ester). Standards for physical properties, chemical properties, and/or procedures for testing purity/properties, are described for plasticizers in the art. Various plasticizers comprise an ester of a monoalcohol and an acid (e.g., a dicarboxylic acid). In many embodiments, the monoalcohol comprises 4 to 13 carbons. In specific aspects, the monoalcohol comprises butanol, 2-ethylhexanol, isononanol, isooctyl, isodecyl, or a combination thereof. Examples of an acid include an azelaic acid, a phthalic acid, a sebacic acid, a trimellitic acid, an adipic acid, or a combination thereof. Examples of such plasticizers include di(2-ethylhexyl) azelate (“DOZ”); di(butyl) sebacate (“DBS”); di(2-ethylhexyl) phthalate (“DOP”); di(isononyl) phthalate (“DINP”); dibutyl phthalate (“DBP”); butyl benzyl phthalate (“BBP”); di(isooctyl) phthalate (“DIOP”); di(idodecyl) phthalate (“DIDP”); tris(2-ethylhexyl) trimellitate (“TOTM”); tris(isononyl) trimellitate (“TINTM”); di(2-ethylhexyl) adipate (“DOA”); di(isononyl) adipate (“DINA”); or a combination thereof. A plasticizer may be classified by a moiety, such as, for example, as an adipate (e.g., DOA, DINA), an azelate (e.g., DOZ), a citrate, a chlorinated plasticizer, an epoxide, a phosphate, a sebacate (e.g., DBS), a phthalate (e.g., DOP, DINP, DIOP, DIDP), a polyester, or a trimellitate (e.g., TOTM, TINTM).

A “sequestrant” is a molecule capable of coordinating (i.e., binding) the metal ions commonly found in natural water to prevent the metal ions from interfering with the action of the other ingredients of the composition. Some chelating/sequestering agents can also function as a threshold agent when included in an effective amount. A sequestrant is also known as a builder. Optionally, the builders can be added, e.g., water soluble inorganic salt builders, preferably sodium salts, such as sodium polyphosphates, e.g. sodium tripolyphosphate and sodium pyrophosphate, sodium carbonate, sodium bicarbonate, sodium sesquicarbonate, sodium silicate, sodium disilicate, sodium metasilicate and sodium borate. In addition to the water soluble inorganic salts, water insoluble builders may also be useful, including the ion exchanging zeolites, such as Zeolite 4A. Organic builders may also be employed. Among suitable organic builders are polyacetal carboxylates, as described in U.S. Pat. No. 4,725,455, and water-soluble salts of lower hydroxycarboxylic acids, such as an alkali metal gluconate. Potassium or sodium gluconate are preferred.

Compositions

The present invention relates to compositions and their use for removing coatings from a substrate. The present invention is directed to a composition comprising (a) surfactants, (b) a sequestrant, and (c) a plasticizer/solvent. The composition may also contain (d) a hydrolyzing agent, e.g., a strong base compound and other additives.

The present stripping compositions can include (a) surfactants, (b) a sequestrant, and (c) a plasticizer/solvent. In an embodiment, the present stripping compositions include, for example, alkali metal gluconate, alcohol ethoxylate, and glycol ether solvent. The inventive stripping compositions can include additional ingredients, for example, in the proportions and amounts described in Table 1. In certain embodiments, the proportions and amounts in Table 1 can be modified by “about”.

TABLE 1

| Component | Wt. % | Wt. % | Wt. % | Wt. % | Wt. % |
|---|---|---|---|---|---|
| Surfactant | 1-15 | 1-25 | 15-30 | 15-45 | 20 |
| Sequestrant | 1-15 | 1-30 | 2-10 | 1-7.5 | 2 |
| Plasticizer | 0.5-15 | 1-5 | 1-2.5 | 1-7.5 | 2.5 |
| Additional | 0-20 | 0.1-10 | 0.25 | 0.2.5 | <0.5 |
| Ingredients | | | | | |

Preferably, the surfactant comprises a mixture of three types of surfactants as Surfactant A, for the penetration of the organic coating; Surfactant B for organic particle formation; and Surfactant C for surface adsorption wherein:
Surfactant A is preferably, one or more surfactants selected from the group consisting of Low Moiety EO Nonionics, ethoxylated diols types, phosphate esters and R-propionic acid monosodium salts;
Surfactant B is preferably, one or more surfactants selected from the group consisting of nionics and nonionics as a co-surafactant and

Surfactant C is preferably, one or more surfactants selected from the group consisting of Amphoterics, ethoxylated diols types and High Moiety EO Nonionics.

In one embodiment, the composition further comprises a hydrolyzing agent present in an amount sufficient to reduce at least one of mechanical strength and adhesion between the coating and the substrate, wherein the hydrolyzing agent is a strong base selected from the group consisting of sodium hydroxide, potassium hydroxide, trisodium phosphate, disodium phosphate, and mixtures thereof.

The total concentration of hydrolyzing agent in solution is that sufficient to achieve attack and break down of the targeted chemical bonds so as to reduce the mechanical strength of the bond between the coating and the substrate, with concentrations between about 1% and about 50% by weight being preferred. In the process of the present invention, hydrolyzing agent is present in a concentration preferably between about 2% and about 25% by weight.

In one specific embodiment, the present invention provides for a composition comprising:

a. from about 1 to about 45 wt. % (at final bath concentration) of a surfactant;

b. from about 1 to 15 wt. % of a solvent; and

c. from about 1 to about 98 wt. % of an alkalinity source.

Optionally, the composition contains one or more of the following:

d. from about 1 to about 10 wt. % of a sequestrant;

e. from about 0 to about 15 wt. % of an alcohol;

f. from about 1 to 15 wt. % of a water-soluble plasticizer;

g. from about 0 to about 5 wt. % of a re-deposition inhibitor; and

h. other additives

In another specific embodiment, the present invention provides for a composition comprising:
a. from about 1 to about 45 wt. % (at final bath concentration) of a stripping agent;
b. from about 1 to 15 wt. % of a solvent; and
c. from about 1 to about 95 wt. % of an alkalinity source.
   wherein the stripping agent comprises a surfactant, a sequestrant, an alcohol, a water-soluble plasticizer, a re-deposition inhibitor, an alkalinity source and mixtures thereof;
   and wherein the surfactant comprises a mixture of three types of surfactants as Surfactant A, for the penetration of the organic coating; Surfactant B for organic particle formation; and Surfactant C for surface adsorption, wherein:
Surfactant A is one or more surfactants selected from the group consisting of Low Moiety EO Nonionics, ethoxylated diols types, phosphate esters and R-propionic acid monosodium salts;
Surfactant B is one or more surfactants selected from the group consisting of anionics and nonionics as a co-surafactant and
Surfactant C is one or more surfactants selected from the group consisting of Amphoterics, ethoxylated diols types and High Moiety EO Nonionics.

The ratio of surfactants A:B:C is about 1:25:15 to about 1:1:1, about 1:20:10 to about 1:3:2, about 1:6:15 to about 1:3:5, or about 1:15:6 to about 1:4:3, for penetrating wetters/particle formers:soft particle adsorbers:metallic surface adsorbers. Preferably, the ratio of surfactants A:B:C is about 1:5:3

Preferably, the surfactant is selected from the group consisting of alcohol ethoxylates (linear and branched), nonylphenols, betaines, phosphate esters, alpha-olefin sulfonates, sulfates of alcohol ethoylates, sodium and ammonium lauryl sulphates, imadazolines, polyglycosides and various alcohols [or selected from C6 to C15 ethoxylated alcohols with an ethoxylation with 2 to 4 moles of ethylene oxide per R—OH].

Preferably, the plasticizer has a boiling point of at least about 100 to about 250° C., is capable of swelling and plasticizing cured coatings; and is selected from the group consisting of glycol, glycol ether, high boiling point ketone (e.g., di-acetone alcohol) or long-chain alcohol (from about C1 to about C15 alcohol). More preferably, the plasticizer is selected from ethylene glycol ether, diethylene glycol ether, propylene glycol ether, dipropylene glycol ether, diethylene glycol monomethyl ether, dipropylene glycol methyl ether, dipropylene glycol normal propyl ether, or mixtures thereof.

In another specific embodiment, the present invention provides for a composition comprising:
a. from about 1 to about 30 wt. % (at final bath concentration) of a surfactant;
b. from about 1 to about 20 wt. % of a sequestrant; and
c. from about 1 to about 15 wt. % of a water-soluble plasticizer;

In another embodiment, the composition further comprises (d) from about 1 to about 95 wt. % of a hydrolyzing agent.

In another embodiment, the composition further comprises from about 2 to about 5 wt. % of an alcohol. In yet another embodiment, the composition further comprises from about 1 to about 2.5 wt. % of a re-deposition inhibitor.

Preferably, the surfactant is preferably a mixture of surfactants, since different activities with respect to different functions/mechanisms involved with the individual surfactants takes place all within one formulation.

In another specific embodiment, the present invention provides for a composition comprising:
a. from about 2.5 to about 15 wt. % (at final bath concentration) of a surfactant blend;
b. from about 1 to about 2 wt. % of a sequestrant;
c. from about 5 to 7 wt. % of a water-soluble plasticizer; and
d. from about 1 to about 2.5 wt. % of a re-deposition inhibitor.

In another embodiment, the composition further comprises (e) from about 1 to about 95 wt. % of a hydrolyzing agent. In another embodiment, the composition further comprises from about 1 to about 15 wt. % of an alcohol. Preferably, the alcohol is a branched or linear alcohol of less than about C15, C14, C13, C12, C11, C10 or less.

In another specific embodiment, the present invention provides for a composition comprising:
a. from about 2.5 to about 15 wt. % (at final bath concentration) of a surfactant;
b. from about 1 to about 30 wt. % of a sequestrant;
c. from about 2 to about 25 wt. % of an alcohol;
d. from about 5 to 7 wt. % of a water-soluble plasticizer; and
e. from about 1 to about 5 wt. % of a re-deposition inhibitor.

In another embodiment, the composition further comprises (f) from about 1 to about 75 wt. % of a hydrolyzing agent. In another embodiment, the composition further comprises from about 1 to about 15 wt. % of an alcohol.

In another specific embodiment, the present invention provides for a composition comprising:
a. from about 2 to about 45 wt. % (at final bath concentration) of a surfactant;
b. from about 1 to about 2 wt. % of a sequestrant;
c. from about 2 to about 5 wt. % of an alcohol;
d. from about 5 to about 15 wt. % of a water-soluble plasticizer;
e. from about 1 to about 5 wt. % of a re-deposition inhibitor; and
f. from about 1 to about 55 wt. % of an alkalinity source.

Some examples of representative constituent concentrations for the present stripping compositions can be found in Table 2, in which the values are given in wt. % of the ingredients in reference to the total composition weight. In certain embodiments, the proportions and amounts in Table 2 can be modified by “about”.

TABLE 2

| Component | Wt. % | Wt. % | Wt. % | Wt. % | Wt. % |
|---|---|---|---|---|---|
| Surfactant | 1-15 | 1-25 | 15-30 | 15-45 | 20 |
| Sequestrant | 1-15 | 1-30 | 2-10 | 1-7.5 | 2 |
| Plasticizer | 0.5-15 | 1-5 | 1-2.5 | 1-7.5 | 2.5 |
| Re-deposition | 0.1-7 | 0.5-10 | 1-5 | 1-3 | 1 |
| inhibitor | | | | | |
| Additional | 0-20 | 0.1-10 | 0.25 | 0.2.5 | <0.5 |
| Ingredients | | | | | |

Embodiments of concentrations of representative constituents for the present stripping compositions can be found in Table 3, in which the values are given in wt. % of the ingredients in reference to the total composition weight. In certain embodiments, the proportions and amounts in Table 3 can be modified by “about”.

TABLE 3

| Component | Wt. % | Wt. % | Wt. % | Wt. % | Wt. % |
|---|---|---|---|---|---|
| Surfactant | 1-15 | 1-25 | 15-30 | 15-45 | 20 |
| Sequestrant | 1-15 | 1-30 | 2-10 | 1-7.5 | 2 |
| Plasticizer | 0.5-15 | 1-5 | 1-2.5 | 1-7.5 | 2.5 |
| Re-deposition | 0.1-7 | 0.5-10 | 1-5 | 1-3 | 1 |
| inhibitor | | | | | |
| Alkaline | 0-45 | 10-55 | 5-25 | 5-45 | 25 |
| Source | | | | | |
| Additional | 0-20 | 0.1-10 | 0.25 | 0.2.5 | <0.5 |
| Ingredients | | | | | |

Surfactants

The stripping agent can be a surfactant or surfactant system. A variety of surfactants can be used in the present stripping composition, including anionic, nonionic, cationic, and zwitterionic surfactants, which are commercially available. In certain embodiments, the surfactants include nonionic surfactants, anionic surfactants, or mixtures thereof.

In certain embodiments, the present composition includes surfactant at about 0.1 to about 60 wt. %, about 1 to about 30 wt. %, about 1 to about 40 wt. %, about 10 to about 50 wt. %, or about 20 to about 40 wt. %. In an embodiment, the present composition includes surfactant at about 30 wt. %. In an embodiment, the surfactant itself is a liquid at room temperature. The composition can include any of these ranges or amounts not modified by about. The stripping composition can include surfactant in an amount effective to provide a desired level of stripping.

Non-limiting examples of representative surfactants which may optionally be used in the practice of this invention include non-ionic, anionic, cationic and amphoteric surfactants, such as monocarboxyl cocoimidoazoline, higher alkyl sulfate sodium salts, tridecyloxy poly(alkyleneoxy ethanol), ethoxylated or propoxylated alkyl phenol, alkyl sulfoamides, C10-18 alkaryl sulfonates such as alkylbenzene sulfonates, cocoamphaodipropionate, cetylpalmitic alkanol amides, hydrogenated castor oil, isooctylphenyl polyethoxy ethanol, sorbitan monopalmitate, C8-18 alkyl pyrrolidone, cocoaminoprpionic acid and polyethoxy amino salts thereof. When used, the amount of surfactant should be sufficient to render the composition miscible. Typically the amount of surfactant is from about 0.1 to about 45 percent by weight of the total composition.

Among the specific nonionic surfactants that may be employed in the practice of the invention may be mentioned 2-ethylhexanol/2 E.O. condensate (trade designation “Ethal EH-2”), 2-ethylhexanol/5 E.O. condensate (trade designation “Ethal EH-5”), isodecanol/4 E.O. (trade designation “Ionol DA-4”), isodecanol/6 E.O. (trade designation “Ionol DA-6”), hexanol, octanol, decanol/3 E.O. condensate (trade designation “Alfonic 610-50R”), octanol, decanol/3 E.O. condensate (trade designation “Alfonic 810-40”) octanol, decanol/5 E.O. condensate (trade designation “Alfonic 810-60”), C9-C11 alkanol/2.5 E.O. condensate (trade designation “Neodol 91-2.5”), lauryl alcohol/4E.O. condensate, (trade designation “Macol LA-4”), tridecanol/3 E.O. condensate (trade designation “Macol TD-3”), tridecanol/4 E.O. condensate (trade designation “Macol TD-4”), decanol/dodecanol/3 E.O. condensate (trade designation “Ethonic 1012-3”), C12-C14 alkanol/2 E.O. condensate (trade designation “Ethonic 1214-2”), C12-C13 linear alcohol/3 E.O. condensate (trade designation “Neodol 23-3”), C12-C15 linear alcohol/3 E.O. condensate (trade designation “Neodol 25-3”), C11-C15 secondary alcohol/3 E.O. condensate (trade designation “Tergitol 15-S-3”), C11-C15 secondary alcohol/5 E.O. condensate (trade designation “Tergitol 15-S-5”), octylphenol ethoxylate (trade designation “Triton X-45”), polyethylene glycol (400) monooleate (trade designation “Mopeg 400 MO”), polyethylene glycol (200) monolaurate (trade designation “Mopeg 200 ML”), soyamide diethanolamide (1:1) trade designation “Mackamide S”), linoleamide diethanolamide (1:1) trade designation “Monamide 15-70W”), lauramide diethanolamide (1:1) (trade designation “Mackamide LLM”), oleamide diethanolamide (1:1) (trade designation “Clindrol 100-0”), and isostearamide diethanolamide (1:1) (trade designation “Monamid 150 IS”). The 1:1 diethanolamides are a class of nonionic surfactants derived from a 1:1 molar reaction between diethanolamine and varying length fatty acids such as stearic or oleic acid and only the 1:1 diethanolamides are useful in the present invention. It will be understood that other nonionic surfactants falling within the above-defined group and having the stated characteristics may also be employed in the practice of the invention.

Among the preferred nonionic surfactants for use in the practice of the invention may be mentioned ethoxylated alkanols and 1:1 diethanolamides and, more specifically, decyl alcohol/4 E.O. condensate, decanol/dodecanol/3 E.O. condensate, C12-C15 linear alcohol/3 E.O. condensate and the alkylphenol ethoxylate sold under the trade designation “Triton X-45”. Further, as specified above, the nonionic surfactant component must have a hydrophilic/lipophilic balance (HLB) between approximately 3 and 12, and preferably, between approximately 8 and 11.

Nonionic surfactants useful in the present compositions, include those having a polyalkylene oxide polymer as a portion of the surfactant molecule. These surfactants can be capped or uncapped. Such nonionic surfactants include, for example, chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates, fatty alcohol ethoxylates (e.g., tridecyl alcohol alkoxylate, ethylene oxide adduct), and the like; nonylphenol ethoxylate, polyoxyethylene glycol ethers, and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer such as those commercially available under the trademark PLURONIC (BASF-Wyandotte), and the like; ethoxylated amines and ether amines commercially available from Tomah Corporation and other like nonionic compounds. Silicone surfactants such as the ABIL B8852 (Goldschmidt) can also be used.

In certain embodiments, the nonionic surfactant includes alkyl phenol ethoxylate, linear and secondary alcohol ethoxylate (fatty alcohol ethoxylate, e.g., tridecyl alcohol alkoxylate, ethylene oxide adduct), ethoxy/propoxy block surfactant, polyether siloxane, or mixture thereof. Examples of suitable nonionic surfactants include EO/PO block nonionic surfactant terminated in PO, silicone nonionic surfactant, benzyl ether of a polyethoxylated primary alcohol, nonylphenol ethoxylate (e.g., nonylphenol 9.5 mole ethoxylate), and the like.

Exemplary nonionic surfactants include known nonionic surfactants which generally consist of a hydrophobic moiety, such as C₆-C₂₀ primary or secondary, branched or straight chain monoalcohols, C8-C18 mono- or dialkyphenols, C6-C20 fatty acid amides, and a hydrophilic moiety which consists of alkylene oxide units. These nonionic surfactants are, for instance, alkoxylation products of the above hydrophobic moieties, containing from 2 to 30 moles of alkylene oxide. As alkylene oxides, ethylene-, propylene- and butylene oxides and mixtures thereof are used. Typical examples of such nonionic surfactants are C9-C11 primary, straight-chain alcohols condensed with 5-9 moles of ethylene oxide, C12-C15 primary straight chain alcohols condensed with from 6-12 moles of ethylene oxide, or with 7-9 moles of a mixture of ethylene oxide and propylene oxide, C11-C15 secondary alcohols condensed with from 3-15 moles of ethylene oxide, and C10-C18 fatty acid diethanolamides, and tertiary amine oxides such as higher alkyl di(lower alkyl or lower substituted alkyl)amine oxides. Other useful nonionic surfactants include certain alkoxylated linear aliphatic alcohol surfactants which are believed to be the condensation products of a C8-C10 hydrophilic moiety with alkylene oxides, especially polyethylene oxide and or polypropylene oxide moieties. Such nonionic surfactants are known to the art.

In certain embodiments, the nonionic surfactant is present at about 1 to about 30 wt. %, about 5 to about 20 wt. %, or about 10 to about 15 wt. %. In an embodiment, the nonionic surfactant is present at about 15 (e.g., 14) wt. %. The composition can include any of these ranges or amounts not modified by about.

Amphoteric surfactants, surfactants containing both an acidic and a basic hydrophilic group can be used in the invention. Amphoteric surfactants can contain the anionic or cationic group common in anionic or cationic surfactants and additionally can contain ether hydroxyl or other hydrophilic groups that enhance surfactant properties. Such amphoteric surfactants include betain surfactants, sulfobetain surfactants, amphoteric imidazolinium derivatives and others. One class of preferred surfactants is the anionic synthetic detergents. This class of synthetic detergents can be broadly described as the water-soluble salts, particularly the alkali metal (sodium, potassium, etc.) salts, or organic sulfuric reaction products having in the molecular structure an alkyl radical containing from about eight to about 22 carbon atoms and a radical selected from the group consisting of sulfonic acid and sulfuric acid ester radicals.

In certain embodiments, the amphoteric surfactant is present at about 1 to about 40 wt. %, about 1 to about 20 wt. %, about 3 to about 15 wt. %, about 5 to about 30 wt. %, about 5 to about 10 wt. %, or about 5 to about 10 wt. %, or about 10 to about 20 wt. %. In certain embodiments, the amphoteric surfactant is present at about 8 wt. % or about 16 wt. %. The composition can include any of these ranges or amounts not modified by about.

Anionic surfactants useful in the present compositions, include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates (e.g, linear dodecyl benzene sulfonic acid or salts thereof), alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, ethoxylated alcohol phosphate esters, and the like. In certain embodiments, the anionic surfactant includes sodium alkylarylsulfonate, alkylbenzenesulfonate (e.g, linear dodecyl benzene sulfonic acid or salts thereof), ethoxylated alcohol phosphate ester, alpha-olefin sulfonate, fatty alcohol sulfate, or mixture thereof.

Preferred anionic organic surfactants include alkali metal (sodium, potassium, lithium) alkyl benzene sulfonates, alkali metal alkyl sulfates, and mixtures thereof, wherein the alkyl group is of straight or branched chain configuration and contains about nine to about 18 carbon atoms. Specific compounds preferred from the standpoints of superior performance characteristics and ready availability include the following: sodium decyl benzene sulfonate, sodium dodecylbenzenesulfonate, sodium tridecylbenzenesulfonate, sodium tetradecylbenzene-sulfonate, sodium hexadecylbenzenesulfonate, sodium octadecyl sulfate, sodium hexadecyl sulfate and sodium tetradecyl sulfate.

In certain embodiments, the anionic surfactant is present at about 1 to about 40 wt. %, about 1 to about 20 wt. %, about 3 to about 15 wt. %, about 5 to about 30 wt. %, about 5 to about 10 wt. %, or about 5 to about 10 wt. %, or about 10 to about 20 wt. %. In certain embodiments, the anionic surfactant is present at about 8 wt. % or about 16 wt. %. The composition can include any of these ranges or amounts not modified by about.

Although not limiting to the present invention, it is believed that surfactant can exist as a complex with one or more salts. Such a complex can be envisioned as similar to hydration of a salt; a hydroxyl group (or other functional group with a free electron pair) on the surfactant may complex a salt like a water of hydration. In an embodiment, the present compositions include a complex of a salt and a surfactant.

Non-limiting examples of representative surfactants which may optionally be used in the practice of this invention include non-ionic, anionic, cationic and amphoteric surfactants, such as monocarboxyl cocoimidoazoline, higher alkyl sulfate sodium salts, tridecyloxy poly(alkyleneoxy ethanol), ethoxylated or propoxylated alkyl phenol, alkyl sulfoamides, C10-18 alkaryl sulfonates such as alkylbenzene sulfonates, cocoamphaodipropionate, cetylpalmitic alkanol amides, hydrogenated castor oil, isooctylphenyl polyethoxy ethanol, sorbitan monopalmitate, C8-18 alkyl pyrrolidone, cocoaminoprpionic acid and polyethoxy amino salts thereof. When used, the amount of surfactant should be sufficient to render the composition miscible. Typically the amount of surfactant is from about 0.1 to about 10 percent by weight of the total composition.

Preferably, the surfactant is a mixture of surfactants selected from alcohol ethoxylates (linear and branched), nonylphenols, betaines, phosphate esters, alpha-olefin sulfonates, sulfates of alcohol ethoylates, sodium and ammonium lauryl sulphates, imadazolines, polyglycosides and various alcohols, preferably C6 to C15 ethoxylated alcohols with an ethoxylation with 2 to 4 moles of ethylene oxide per R—OH; more preferably C9 to C11 ethoxylated alcohols with an ethoxylation with 2.5 to 3 moles of ethylene oxide per R—OH, most preferable is Tomadol 91-2.5 (is this the same as ethoxylated 2,4,7,9-tetramethyl 5 decyn-4, 7 Diol CAS No. 9014-85-1?).

Sequestrant/Builder

The stripping agent can include one or more sequestrant or builder. In general, a sequestrant is a molecule capable of coordinating (i.e., binding) the metal ions commonly found in natural water to prevent the metal ions from interfering with the action of the other ingredients of a stripping composition. Some chelating/sequestering agents can also function as a threshold agent when included in an effective amount.

A variety of sequestrants or builders can be used in the present composition, including, for example, organic phosphonate, aminocarboxylate, condensed phosphate, polyphosphate, inorganic builder, polymeric polycarboxylate, mixture thereof, or the like. Such sequestrants/builders are commercially available.

Suitable organic phosphonates include organic-phosphonic acids, and alkali metal salts thereof. Some examples of suitable organic phosphonates include:
1-hydroxyethane-1,1-diphosphonic acid: CH3C(OH)[PO(OH)2]2;
aminotri(methylenephosphonic acid): N[CH2PO(OH)2]3;
aminotri(methylenephosphonate), sodium salt 1 2-hydroxyethyliminobis(methylenephosphonic acid): HOCH2CH2N [CH2PO(OH)2]2;
diethylenetriaminepenta(methylenephosphonic acid): (HO)2POCH2N[CH2CH2N[CH2PO(OH)2]2]-2;
2-phosphonobutane-1,2,4-tricarboxylic acid;
diethylenetriaminepenta(methylenephosphonate), sodium salt: C9H(28-x)N3NaxO15P5 (x=7);
hexamethylenediamine(tetramethylenephosphonate), potassium salt: C10H(28-x)N2KxO12P4 (x=6);
bis(hexamethylene)triamine(pentamethylenephosphonic acid): (HO2)POCH2N[(CH2)6N[CH2PO(OH)2]2]-2; and
phosphorus acid H3PO3; and other similar organic phosphonates, and mixtures thereof.
   The sequestrant can be or include aminocarboxylic acid type sequestrant. Suitable aminocarboxylic acid type sequestrants include the acids or alkali metal salts thereof, e.g., amino acetates and salts thereof. Some examples include the following:
N-hydroxyethylaminodiacetic acid;
hydroxyethylenediaminetetraacetic acid, nitrilotriacetic acid (NTA);
ethylenediaminetetraacetic acid (EDTA);
N-hydroxyethyl-ethylenediaminetriacetic acid (HEDTA);
diethylenetriaminepentaacetic acid (DTPA); and
alanine-N,N-diacetic acid;
   and the like; salts thereof, and mixtures thereof.

In certain embodiments, the aminocarboxylate includes ethylenediamine tetraacetic acid (EDTA), diethylenetriamine pentaacetic acid (DTPA), their alkali metal salts, or mixtures thereof. In an embodiment, the aminocarboxylate includes the sodium salt of EDTA.

In certain embodiments, the aminocarboxylate is present at about 0.1 to about 30 wt. %, about 0.2 to about 10 wt. %, or about 0.5 to about 2 wt. %. In an embodiment, the aminocarboxylate is present at about 1 wt. %. The composition can include any of these ranges or amounts not modified by about.

Examples of condensed and/or polyphosphates include sodium and potassium orthophosphate, sodium and potassium pyrophosphate, sodium and potassium tripolyphosphate, sodium hexametaphosphate, and the like, e.g., the sodium salt, e.g., of pyrophosphate. In one embodiment, the present composition includes as a builder, chelator, or sequestrant a condensed phosphate, such as tetrasodium pyrophosphate.

Polycarboxylates include, for example, polyacrylic acid, maleic/olefin copolymer, acrylic/maleic copolymer, polymethacrylic acid, acrylic acid methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

In an embodiment, the present composition includes, as sequestrant or builder, a condensed phosphate and aminocarboxylate, for example, tetrasodium pyrophosphate and EDTA. In an embodiment, the sodium salt of condensed phosphate is preferred to the corresponding potassium salt.

The present materials may also comprise an effective amount of a water-soluble organic phosphonic acid which has sequestering properties. Preferred phosphonic acids include low molecular weight compounds containing at least two anion-forming groups, at least one of which is a phosphonic acid group. Such useful phosphonic acids include mono-, di-, tri- and tetra-phosphonic acids which can also contain groups capable of forming anions under alkaline conditions such as carboxy, hydroxy, thio and the like. Among these are phosphonic acids having the formulae:
R1N [CH2PO3H2]2 or R2C(PO3H2)-2OH
wherein R1 may be -[(lower)alkylene]N[CH2PO3H2]-2 or a third CH2PO3H2 moiety; and wherein R2 is selected from the group consisting of C1-C6 alkyl.

The phosphonic acid may also comprise a low molecular weight phosphonopolycarboxylic acid such as one having about 2-4 carboxylic acid moieties and about 1-3 phosphonic acid groups. Such acids include 1-phosphono-1-methylsuccinic acid, phosphonosuccinic acid and 2-phosphonobutane-1,2,4-tricarboxylic acid.

Other organic phosphonic acids include 1-hydroxyethylidene-1,1-diph-osphonic acid (CH3C(PO3H2)2OH), available from Monsanto Industrial Chemicals Co., St. Louis, Mo. as Dequest 2010, a 58-62% aqueous solution; amino [tri(methylenephosphonic acid)] (N[CH2PO3H2]3), available from Monsanto as Dequest 2000, a 50% aqueous solution; ethylenediamine [tetra(methylene-phosphonic acid)] available from Monsanto as Dequest 2041, a 90% solid acid product; and 2-phosphonobutane-1,2,4-tricarboxylic acid available from Mobay Chemical Corporation, Inorganic Chemicals Division, Pittsburgh, Pa. as Bayhibit AM, a 45-50% aqueous solution. It will be appreciated that, the above-mentioned phosphonic acids can also be used in the form of water-soluble acid salts, particularly the alkali metal salts, such as sodium or potassium; the ammonium salts or the alkylol amine salts where the alkylol has 2 to 3 carbon atoms, such as mono-, di-, or tri-ethanolamine salts. If desired, mixtures of the individual phosphonic acids or their acid salts can also be used. Further useful phosphonic acids are disclosed in U.S. Pat. No. 4,051,058, the disclosure of which is incorporated by reference herein. Of the phosphonic acids useful in the present invention, those which do not contain amino groups are especially preferred, since they produce substantially less degradation of the active chlorine source than do phosphonic acids comprising amino groups.

The present compositions can also incorporate a water soluble acrylic polymer which can act to condition the wash solutions under end-use conditions. Such polymers include polyacrylic acid, polymethacrylic acid, acrylic acid-methacrylic acid copolymers, hydrolyzed polyacrylamide, hydrolyzed polymethacrylamide, hydrolyzed acrylamidemethacrylamide copolymers, hydrolyzed polyacrylonitrile, hydrolyzed polymethacrylonitrile, hydrolyzed acrylonitrilemethacrylonitri-le copolymers, or mixtures thereof. Water-soluble salts or partial salts of these polymers such as the respective alkali metal (e.g. sodium potassium) or ammonium salts can also be used. The weight average molecular weight of the polymers is from about 500 to about 15,000 and is preferably within the range of from 750 to 10,000. Preferred polymers include polyacrylic acid, the partial sodium salt of polyacrylic acid or sodium polyacrylate having weight average molecular weights within the range of 1,000 to 6,000. These polymers are commercially available, and methods for their preparation are well-known in the art.

For example, commercially-available water-conditioning polyacrylate solutions useful in the present stripping solutions include the sodium polyacrylate solution, Colloid 207 (Colloids, Inc., Newark, N.J.); the polyacrylic acid solution, Aquatreat AR-602-A (Alco Chemical Corp., Chattanooga, Tenn.); the polyacrylic acid solutions (50-65% solids) and the sodium polyacrylate powders (m.w. 2,100 and 6,000) and solutions (45% solids) available as the Goodrites K-700 series from B.F. Goodrich Co.; and the sodium- or partial sodium salts of polyacrylic acid solutions (m.w. 1000-4500) available as the Acrysol series from Rohm and Haas.

Such sequestrants include materials such as, complex phosphate sequestrants, including sodium tripolyphosphate, sodium hexametaphosphate, and the like, as well as mixtures thereof. Phosphates, the sodium condensed phosphate hardness sequestering agent component functions as a water softener, a cleaner, and a detergent builder. Alkali metal (M) linear and cyclic condensed phosphates commonly have a M2O; P2O5 mole ratio of about 1:1 to 2:1 and greater. Typical polyphosphates of this kind are the preferred sodium tripolyphosphate, sodium hexametaphosphate, sodium metaphosphate as well as corresponding potassium salts of these phosphates and mixtures thereof. The particle size of the phosphate is not critical, and any finely divided or granular commercially available product can be employed.

Sodium tripolyphosphate is a preferred inorganic hardness sequestering agent for reasons of its ease of availability, low cost, and high stripping power. Sodium tripolyphosphate acts to sequester calcium and/or magnesium cations, providing water softening properties. It contributes to the removal of soil from hard surfaces and keeps soil in suspension. It has little corrosive action on common surface materials and is low in cost compared to other water conditioners. Sodium tripolyphosphate has relatively low solubility in water (about 14 wt. %) and its concentration must be increased using means other than solubility. Typical examples of such phosphates being alkaline condensed phosphates (i.e. polyphosphates) such as sodium or potassium pyrophosphate, sodium or potassium tripolyphosphate, sodium or potassium hexametaphosphate, etc.; carbonates such as sodium or potassium carbonate; borates, such as sodium borate; etc.

Solvents (Plasticizers)

The solvent can impart advantageous properties during use of the present stripping compositions. Advantageously, the solvent has a flash point higher than the temperatures employed for processing the present stripping composition (e.g., greater than 60, 80, 90, 100, 110, 120 or 130° C.). In an embodiment, the solvent or solvents are water miscible, have a flash point higher than 95° C., and remove coatings.

Suitable solvents include glycol ethers. Some glycol ethers are also known as cellosolves. In an embodiment, the solvent includes or is a glycol ether. Suitable glycol ethers include ethylene glycol ethers and propylene glycol ethers, for example, ethylene glycol ethers, diethylene glycol ethers, propylene glycol ethers, dipropylene glycol ethers, and the like. Suitable ethers include, for example, methyl ethers, ethyl ethers, propyl (n- or i-) ethers, and butyl (n-, i-, or t-) ethers. For example, glycol ether solvents include ethylene glycol methyl ether, ethylene glycol ethyl ether, ethylene glycol propyl ether, ethylene glycol butyl ether, diethylene glycol methyl ether, diethylene glycol ethyl ether, diethylene glycol propyl ether, diethylene glycol butyl ether, propylene glycol methyl ether, propylene glycol ethyl ether, propylene glycol propyl ether, propylene glycol butyl ether, dipropylene glycol methyl ether, dipropylene glycol ethyl ether, dipropylene glycol propyl ether, dipropylene glycol butyl ether, mixtures thereof, and the like.

In certain embodiments, the ethylene glycol ether includes ethylene glycol monoethyl ether, ethylene glycol monobutyl ether, diethylene glycol monomethyl ether, diethylene glycol monoethyl ether, diethylene glycol monobutyl ether, mixtures thereof, and the like. In certain embodiments, the propylene glycol ether includes propylene glycol monoethyl ether, propylene glycol monobutyl ether, dipropylene glycol monomethyl ether, dipropylene glycol monoethyl ether, dipropylene glycol monobutyl ether, mixtures thereof, and the like.

Preferably, the plasticizer is a glycol, glycol ether, high boiling point ketone (e.g., di-acetone alcohol) or long-chain alcohol (from about C10 to about C15 alcohol). More preferably, the placticizer is a glycol ether, could it be any e.g., ethylene glycol ether, diethylene glycol ether, propylene glycol ether, dipropylene glycol ether, diethylene glycol monomethyl ether, dipropylene glycol methyl ether, dipropylene glycol normal propyl ether, or mixtures thereof.

The glycol ether compounds useful in the invention are preferably lower alkyl glycol ethers, which are colorless liquids with mild pleasant odors. The glycols are excellent solvents and coupling agents and are typically miscible with aqueous compositions of the invention. The boiling points of the materials fall within a range of about 100 to about 250° C. The glycol solvents are based on ethylene glycol, diethylene glycol, triethylene glycol, propylene glycol, dipropylene glycol, tripropylene glycol or mixed ethylene propylene glycol ethers. The preferred glycol ethers are lower alkyl ethers; the term lower alkyl indicates a C1-8 alkyl group including methyl, ethyl, propyl, isopropyl, n-butyl, isobutyl, tertiary butyl and n-amyl, isoamyl, tertiary amyl, etc. Such glycols can include propylene glycol methyl ether, dipropylene glycol methyl ether, dipropylene glycol ethyl ether, tripropylene glycol methyl ether, propylene glycol isobutyl ether, ethylene glycol methyl ether, ethylene glycol ethyl ether, ethylene glycol diethyl ether, ethylene glycol dibutyl ether, diethylene glycol methyl ether, diethylene glycol dimethylether, diethylene glycol ethyl ether, diethylene glycol diethyl ether, diethylene glycol butyl ether, ethylene glycol dimethyl ether and other similar materials. The preferred solvent is a monomethyl glycol ether solvent including propylene glycol methyl ether, diethylene glycol methyl ether, dipropylene glycol methyl ether, tripropylene glycol methyl ether and mixtures thereof.

In certain embodiments, the present stripping composition includes about 10 to about 30 wt. %, about 15 to about 25 wt. %, or about 18 to about 22 wt. % solvent. In an embodiment, the solvent is present at about 20 wt. %. In certain embodiments, the present stripping composition includes two or three solvents, each present at about 5 to about 30 wt. %, about 1 to about 20 wt. %, or about 0.5 to about 10 wt. % solvent. In an embodiment, each of the two or three solvents is present at about 5 wt. %, at about 7.5 wt. %, or at about 1 wt. %. The composition can include any of these ranges or amounts not modified by about.

Anti-Deposition Agent

The compositions of the present invention can also include an anti-redeposition agent capable of facilitating sustained suspension of coatings in a solution and preventing the removed coatings from being redeposited onto the substrate being cleaned. Examples of suitable anti-redeposition agents include surfactants, metasilicates, zeolites, fatty acid amides, fluorocarbon surfactants, complex phosphate esters, styrene maleic anhydride copolymers, and cellulosic derivatives such as hydroxyethyl cellulose, hydioxypropyl cellulose, and the like. The present composition can include about 0.5-15 wt. %, e.g., about 1-5 wt. %, of an anti-redeposition agent. Preferably, the re-deposition inhibitor is a surfactant, a metasilicate, a zeolite or any combination thereof.

In certain embodiments, the anti-redeposition agent is present at about 0.1 to about 30 wt. %, about 0.2 to about 10 wt. %, or about 0.5 to about 2 wt. %. In an embodiment, the anti-redeposition agent is present at about 1 wt. %. The composition can include any of these ranges or amounts not modified by about.

Alternatively, alkali metal silicate, alkali metal nitrite, alkali metal carbonate, and/or alkali metal phosphate components may be added to the composition of this invention. The alkali metal silicate component functions as both an alkalinity contributor as well as an anti re-deposition aid, is preferably present in the amount of between about 0.1 to 15 wt. % and is constituted by a sodium or potassium metasilicate, orthosilicate or other water-soluble silicate. The alkali metal nitrite component can function as a metal and metal alloy corrosion inhibitor, is preferably present in the amount of between about 0.5 to 10 wt. % and is preferably constituted by sodium or potassium nitrite.

Alkaline Source

The compositions of the present invention can contain a source of alkalinity, which can be an organic source or an inorganic source of alkalinity. Preferably, the alkalinity source is an alkali metal hydroxide (e.g., sodium hydroxide or potassium hydroxide), alkali metal silicate (e.g., sodium metasilicate), an alkali metal phosphate, an amine compound or mixtures thereof.

Organic sources of alkalinity are often strong nitrogen bases including, for example, ammonia, monoethanol amine, monopropanolamine, diethanolamine, dipropanolamine, triethanolamine, tripropanolamine, etc.

The inorganic alkali content of the alkaline cleaners of this invention is preferably derived from sodium or potassium hydroxide which can be used in both liquid (about 10 to 60 wt. % aqueous solution) or in solid (powdered, flake or pellet) form. The preferred form is commercially-available potassium hydroxide, which can be obtained in aqueous solution at concentrations of about 50 wt % and in a variety of solid forms of varying particle size and shape.

For some applications, it is desirable to replace a part or all of the alkali metal hydroxide with an alkali metal silicate such as anhydrous sodium metasilicate. When incorporated into the composition within the preferred temperature ranges, at a concentration of about 1-20% by weight, anhydrous sodium metasilicate can protect metal surfaces against corrosion.

The compositions of the invention may further comprise an alkanolamine. The alkanolamines include, e.g., monoalkanolamines, dialkanolamines, trialkanolamines, and alkylalkanolamines, such as alkyl-dialkanolamines, and dialkyl-monoalkanolamines or combinations thereof. The alkanol and alkyl groups are generally short to medium chain length, that is, from 1 to 7 carbons in length. For di- and trialkanolamines and dialkyl-monoalkanolamines, these groups can be combined on the same amine to produce for example, methylethylhydroxylpropylhydroxylamine, to name but a few such possibilities. Preferred alkanolamines are trialkanolamines, including triethanolamine. Alkanolamine is desirably present in an amount of from about 0.1% to about 10% by weight, or more particularly from about 0.5% to about 5% by weight of the composition or more particularly from about 1% to about 2.5% by weight of the composition

Alkanolamines suitable for use in the present invention are preferably miscible with the hydroxylamine and are preferably water-soluble. Additionally, the alkanolamines useful in the present invention preferably have relatively high boiling points, preferably 75° C. or above.

Suitable alkanolamines are primary, secondary or tertiary amines and are preferably monoamines, diamines or triamines. The alcohol group of the alkanolamines preferably has from 1 to 6 carbon atoms, and can be based on a linear, branched or cyclic alcohol.

Examples of suitable alkanolamines include monoethanolamine, diethanolamine, morpholine, dimethylethanolamine, diethylethanolamine, triethanolamine, tertiarybutyldiethanolamine, isopropanolamine, diisopropanolamine, 2-amino-1-propanol, 3-amino-1-propanol, isobutanolamine, 2-(2-aminoethoxy)ethanol (diglycolamine), 2-(2-aminoethoxy)propanol and 1-hydroxy-2-aminobenzene. Also useful are, inter alia, alkylaminoethanols such as dimethylaminoethanol or complexes based on a TPA amine such as N-ethylmorpholine complex with 4-methyl-gamma-oxo-benzenebutanoic acid. A preferred organic amine(s) comprises an amine selected from the group consisting of: diglycolamine (DGA), methyldiethanolamine (MDEA), pentamethyldiethylenetriamine (PMDETA), triethanolamine (TEA), triethylenediamine (TEDA), hexamethylenetetramine, 3,3-iminobis (N,N-dimethylpropylamine), and monoethanolamine.

Additional Components

In addition to the above-noted components of the compositions of the invention, various optional adjuvants can be incorporated. These include thickeners, diluents, brighteners, fragrances, dyes, opacifiers, chelants, pH adjustants and anti-rust additives.

Corrosion inhibitors may optionally be added to the composition. Corrosion inhibitors, also known as anti-corrosive or anti-rust agents, reduce the degradation of the metallic parts contacted by the detergent and are incorporated at a level of about 0.1% to about 15%, and preferably about 0.5% to about 5% by weight of the total composition. The use of such corrosion inhibitors is preferred when the detergent is in contact with a metal surface. Suitable corrosion inhibitors include alkyl and aryl carboxylic acids and carboxylate salts thereof; sulfonates; alkyl and aryl esters; primary, secondary, tertiary and aryl amines; phosphoric esters; epoxides; mercaptans; and diols. Also suitable are the C12-C20 fatty acids, or their salts, especially aluminium tristearate; the C12-C20 hydroxy fatty acids, or their salts; and neutralized tall oil fatty acids. Phosphonated octa-decane and other anti-oxidants such as betahydroxytoluene (BHT) may also be used.

Other non-limiting examples of representative corrosion inhibitors include ethoxylated butynediol, petroleum sulfonates, blends of propargyl alcohol and thiourea. If used, the amount of such corrosion inhibitors is typically up to about 1, 2, 3, 4, 5, 6, 7, 8, 9 or 10% by weight of the total composition.

Other useful corrosion inhibitors include organic zinc complexes such as a zinc citrate, zinc hydroxy oxime complexes, and zinc copolymer complexes of acrylic acid ethacrylate; nitrogen and sulfur-containing aryl heterocycles; alkanolamines such as triethanolamine; amine-neutralized alkyl acid phosphates; dibasic acids neutralized with amines, where the dibasic acids include, but are not limited to, adipic acid, succinic acid, sebacic acid, glutaric acid, malonic acid, suberic acid and examples of amines include, but are not limited to, methylamine, ethylamine, ethanolamine, diethanolamine, triethanolamine and N,N-dimethylcyclohexylamine, and mixtures thereof. Each of the above-mentioned anti-corrosives can be used individually or in combination thereof, or in combination with other types of additives.

Optionally, the compositions of the invention may also contain a thickener which functions not only as a viscosifying thickener but also as an emulsion stabilizing agent stabilizing the emulsions of the invention against separation at elevated temperatures. Illustrative thickeners which may be used in the practice of the invention include acrylic acid/alkyl methacrylate copolymers (Acrysol ICS-1 or Acusol 820), carboxy acrylic polymers (Carbopol 940), guar gums, xanthan gums, polyacrylic acid crosslinked with polyalkenyl polyvinyl alcohol, ammonium alginate and sodium alginate. Other thickeners known to the art may also be used. When incorporated into the composition of the invention, preferably from approximately 0.1 to 2 wt. % of the thickener is used. The preferred thickeners include acrylic acid/alkyl methacrylate copolymers and carboxy acrylic polymers. Where the thickener component is one which contains free acidic groups (e.g. Accusol 820 or Carbopol 940), a neutralizing base such as mono-, di- or triethanolamine or other neutralizing base is incorporated to ionize or neutralize the free acid groups and produce the full thickening effect of the thickener component.

The use of one or more pH-adjusting agents, including minor amounts of mineral acids, basic compositions, and organic acids may be used. An exemplary composition includes citric acid, such as is available in an anhydrous salt form of an alkali metal citric acid. The addition of an effective amount of such a pH-adjusting agent is useful in establishing a targeted pH range for compositions according to the invention. The addition of an effective amount of a pH buffering composition so as to maintain the pH of the inventive compositions may also be added. While the composition of the invention generally does not require a pH buffering composition, the use of such a pH buffering composition may provide the benefit of hard water ion sequestration. Examples of such useful pH buffer compounds and/or pH buffering systems or compositions are alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, citrates, and their alkali metal salts. Such buffers keep the pH ranges of the compositions of the present invention within acceptable limits. Others, not particularly elucidated here may also be used. Preferably, citric acid, such as is available in an anhydrous salt form of an alkali metal citric acid is added as it is readily commercially available, and effective. The addition of such a buffering agent is desirable in certain cases wherein long term, i.e., prolonged storage, is to be anticipated for a composition, as well as insuring the safe handling of the aqueous composition.

Chelating agents may also be added to the composition of this invention to complex with metal ions which may cause degradation of the peroxide. When used, chelating agents may be used in an amount up to about 10% by weight of the total composition. Representative examples of such chelating agents include, but are not limited to, ethylene diamine tetraacetic acid (EDTA) and its metal salts, diethylene triamine pentaacetic acid, polyphosphates and phosphonic acids, and the like.

The ingredients may optionally be processed in a minor but effective amount of an aqueous medium such as water to achieve a mixture, to aid in the solidification, to provide an effective level of viscosity for processing the mixture, and to provide the processed composition with the desired viscosity. In one embodiment, the water serves as a processing medium and also forms part of the binding agent, as described hereinabove. The mixture during processing can include aqueous medium at up to about 50 wt. %, at about 0.2 to about 15 wt. %, about 0.2 to about 10 wt. %, about 0.3 to about 7.5 wt. %, or about 0.5 to about 10 wt. %.

The compositions of this invention may also optionally contain a wide variety of other organic cosolvents. Likewise, the present invention may be practiced in the absence of one or more of such solvents. Non-limiting examples of representative classes of such other cosolvents include hydrocarbons apart from the alkyl-substituted cycloalkanes, glycols, glycol ethers, glycol ether esters, ethers, esters, phenols, glycols, sulfur-based solvents, chlorinated hydrocarbons, aromatic hydrocarbons nitrated hydrocarbons, amides, and ketones. Such cosolvents may be polar or non-polar, may be protic or aprotic, may be cyclic, branched, or straight-chain, and may contain one or more functional groups. Representative examples of common hydrocarbon solvents include hexane, toluene, xylene, and mixtures of aliphatic and aromatic hydrocarbons. Representative examples of common ether solvents include dibutyl ether, ethyl ether, and diphenyl ether. Representative examples of common ester solvents and lactones include material such as butyrolactone, ethyl acetate, butyl acetate, DBE (dibasic ester mixture from DuPont). Representative examples of common phenols include phenol and the cresols and resorinols. Representative examples of common glycol solvents include ethylene, propylene and butylene glycols as well as methyl propane diol. Representative examples of common sulfur-based solvents include dimethylsulfoxide (DMSO) and sulfolane. Representative examples of common chlorinated hydrocarbon solvents include methylene chloride, methyl chloroform, chlorobenzenes and dichlorobenzenes. Representative examples of common nitrated hydrocarbon solvents include nitroethane and nitropropane. Representative examples of common amide solvents include formamide, dimethyl formamide, acetamide, and dimethylacetamide. Representative examples of common ketone solvents include acetone, methyl ethyl ketone (MEK), and methyl isobutyl ketone and methyl isoamylbutone.

The solution concentrates of the invention further include water sufficient to provide the remaining weight of the composition. Deionized or distilled water is preferably employed.

Immersion Method for Ferrous Metals

In one embodiment, the present invention provides for an immersion method for the removal of cured and uncured paint and coatings from ferrous metals using the compositions described herein. The basic technology developed can best be characterized as a controlled dissolved solids catalytic alkaline emulsion de-polymerization via surface-active micelle formation of organic suspended solids.

In one embodiment, the composition used in the removal of coatings from a ferrous metal substrate includes blends of surfactants that initially penetrate and expand the macromolecular lattice for cured and uncured coating particles (or help to create and release particles out of existing cross-linked films) following the surface adsorption and alignment of additional surfactants onto the released organic particle, thereby constituting the formation of a stable micelle.

Furthermore, that the surfactants utilized are preferably alkaline stable for a pH up to about 10, 11, 12, 13, 13.5 or 14 or more; at elevated temperatures up to 120° C. for 10 days. The resulting micelle nucleus (“organic particle”), being effectively isolated from the bulk paint removal bath or solution. The surfactants utilized include, but are not limited to, alcohol ethoxylates (linear and branched), nonylphenols, betaines, phosphate esters, alpha-olefin sulfonates, sulfates of alcohol ethoylates, sodium and ammonium lauryl sulphates, imadazolines, polyglycosides and various alcohols.

In another embodiment, blends of surfactants, sequestrants, alcohols and glycol ethers are utilized to penetrate, swell and expand the macromolecular lattice and finally exhibit a strong electrochemical affinity for surface migration and coating to the solid-solid interface; thus defeating and competing with the coating adhesion mechanism(s) of the previously adhered film.

Preferably, the compositions are in an aqueous alkaline (caustic) medium intended to de-polymerize (break bonds and chains) the macromolecular lattice via attack upon “ester” and “ether” bonds of organic resins and elastomers; as present in the coating. Without wishing to be bound in any way by theory, it is believed the resulting hydronium ion (OH—), based on a controlled equillibria Ksp, to have limited access to the interior of the lattice by absorption of the bulk media during the swelling process, but having a limited contact time until the formation of the subsequent micelle. In this way, the free hydronium ion takes on a “catalytic” role in breaking pre-selected bonds for a limited time until surfactant alignments based on pre-selected affinities effect the formation of “suspended” micelles that are no longer subject to conversion into dissolved solids over time. This is fundamentally different to standard alkaline systems that effect coating removal by digestion (bond breaking) of all organic content into either dissolved and/or precipitated solids including released inorganic content as a by-product of digestion.

Therefore, the system generates “suspended solids” as opposed to dissolved and precipitated solids.

Generally, it is known that bath failure and removal efficacy in earlier methods is directly proportional to a total dissolved solids range of 25% to 75%, whereby depolymerization will not occur in the present, aqueous system at dissolved solids rate in excess of 75% solids content including basic chemistry and contaminants combined.

Preferably, the stabilized (digestion resistant) suspended solids are removed by filtration or other acceptable mechanical separation process. Therefore, the resulting bath does not require dumping due to saturation by dissolved solids. Only bulk solution losses due to carry out and evaporation need to added back or replenished.

Additionally, it has been a common practice in industry to utilize a two phase bulk solution; a lower high density aqueous phase containing predominantly the inorganic constituents and an upper supernatant organic phase, whereby the supernatant phase released partially soluble organics to the aqueous phase based on an overall Ksp/dissolved solids condition. This essentially functions as a self replenishing layer to the lower aqueous bulk phase. With respect to the current invention, this technique is utilized in order to provide a longer “half-life” of the greatly increased organic and surfactant content of the system as compared to other technologies, whilst in the presence of the strong alkali catalyst. The aqueous component and organic phase are packaged separately prior to introduction to the bath. This practice greatly increases bath effectiveness and does not subject organics in the system to “attack” from within via the alkali catalyst.

In one embodiment, the bath temperature is maintained at the “cloud point” of the selected surfactant so that surface activity and affinities are driven to maximum levels. This synergistically increases the penetrative performance and adhesion defeating properties of the overall paint and coating removal system. In one preferred embodiment, the surfactants of a linear ethoxylated alcohol type from about C6 to about C15 with a relatively low order of ethoxylation with about 1 to about 8, preferably about 2 to about 4 moles of ethylene oxide per R—OH are used for paint penetration and solid-solid interface affinity. Thus, it is preferred that to have a low HLB or hydrophile-lipophile balance and, furthermore, that a high HLB co-surfactant is utilized with the ethoxylated alcohol in order to achieve solubility in an aqueous phase.

Optionally, the addition of from about 0 to 5% wt. % silicic acid salts, metasilicate salts with five waters of hydration and ortho silicates can serve to protect dissimilar metallic components, welds, annealed and treated spring steels from repeated bath degradation.

In another embodiment, the ability to remove multiple layers of cured paint or coatings over time, up to 20 coats with an increase of about 0 to about 5%, preferably about 1% low HLB linear alcohol ethoxylate.

The methods of the invention further include water sufficient to rinse off the remaining composition after treatment. Deionized or distilled water is preferably employed.

Immersion Method for Non-Ferrous Metals

Another embodiment provides for an immersion method for the removal of cured paints and coatings from non-ferrous metal substrates.

Immersion Method for Polymeric Substrates

Another embodiment provides for an immersion method for the removal of cured paints and coatings from polymeric substrates.

It was the intention in this development to develop a composition that was low cost, recovered raw material content of molded thermoplastic parts in granule form for remolding and/or recovered whole parts to be returned for repainting and the resulting productivity gain in the molding process due to scrap as a result of unacceptable paint defects. The basic technology developed can best be characterized as surface selective emulsion de-polymerization via surface active induced adhesive failure of organic coatings on polymeric substrates This invention is presently effective on nylons, TPO (polyolefins and rubber modified polyolefins), HDPE, LDPE, polycarbonates, olypropylene (PP) and polyvinyl chloride (PVC).

In the process of the present invention, elevated temperatures may be employed in the attritive environment in order to further promote removal of the coating from the substrate. The process of the present invention preferably proceeds at temperatures below the degradation temperatures for the substrate material. The process temperature will vary depending upon the substrate processed, e.g., with a thermoplastic. The process temperature generally can be in a range between about 25° C. and about 140° C.

In situations in which the thermoplastic substrate to be processed is a polycarbonate or polycarbonate alloy, it is anticipated that the process temperature will be between about 50° C. and about 125° C. In situations in which the thermoplastic substrate to be processed is a TPO, the process temperature can be between about 75° C. and about 120° C. without degradation. Preferably, the process temperature is in a range between about 95° C. and about 115° C.

The coating which can be effectively removed by the process of the present invention generally has a thickness less than 10 mil with a surface thickness between about 1-5 mil being optimum.

Materials such as the mechanical bond strength reducers employed in the compositions can be further processed to remove undesirable coating remaining therein. This can be accomplished by any suitable procedure such as filtration, centrifugation or the like. The fluid can then be reprocessed for further use in the process of the present invention. The separated material can be recycled for reuse without any appreciable loss of activity with regard to the process of the present invention.

The amount of time during which the substrate reside in the attritive environment will depend upon various factors; among these are the initial size of the substrate, process temperature, thickness of the coating to be removed and the presence or nature of any chemical additives. The reaction time is generally determined to be that necessary to achieve removal of the coating. In general, the reaction time is between about 1 hour and about several days, depending upon economic considerations.

If necessary and/or desired to render any remaining trace amounts of coating (s) substantially non-deleterious in any subsequent re-manufacturing of the stripped polymeric substrate, the present inventive process may further comprise an in situ compatibilization step. Preferably, this step occurs separately from, and after the attritive step. The polymeric substrate may be preferably processed in the attritive environment in the presence of a suitable hydrolyzing agent for an interval sufficient to initiate hydrolysis and break down of the coating (e.g., paint). The partially stripped polymeric substrate is then recovered, washed to remove residual hydrolyzing agent, and dried. The polymeric substrate may then optionally be melt processed under standard conditions with the addition of chemical additive(s) which form multi-functional compatibilizing agent(s).

In one specific embodiment, the polymeric substrate is selected from the group consisting of acetate rayon, aliphatic and aromatic polyamides, aliphatic and aromatic polyesters, allyl resin, (allyl), AS resins, butadiene resins, chlorinated polyethylene, conductive resins, copolymerised polyamides, copolymers of ethylene and vinyl acetate, cuprammonium rayons and natural and synthetic rubbers, EEA resins, epoxy resins (e.g., bisphenol, dihydroxyphenol, and novolak), ether ketone resins, fluorine resins, fluorocarbon polymers, fluoroplastics, (PTFE), (FEP, PFA, CTFE, ECTFE, ETFE), high density polyethyelenes, ionomer resins, low density polyethylenes, natural polymers such as cellulosics, nylons, polyacetal, (acetal), polyacrylates, (acrylic), polyacrylonitrile, (PAN), (acrylonitrile), polyamide, (PA), (nylon), polyamide-imide, (PAI), polyaryletherketone, (PAEK), (ketone), polybutylene terephthalate, polybutylene, (PB), polycarbonate, (PC), polycarbonates, polydicyclopentadiene, (PDCP), polyketones, (PK), polyester block copolymers, polyesters, polyesterurethane, polyesterurethaneurea, polyether and polyester block polymers, polyether ketoneketone (PEKK), polyetherether ketone (PEEK), polyetherimide, (PEI), polyethers, polyethersulfone, (PES), polyetherurethane, polyetherurethaneurea, polyethylene isoplthalate, polyethylene terephthalate, polyethylene, (PE), polyethylenechlorinates, (PEC), polyglycolic acid, polyhexamethylene terephthalate, polyimide, (PI), polylactic acid, polymethylpentene, (PMP), poly-m-phenylene isophthalamide, polyolefins, polyphenylene oxide, (PPO), polyphenylene sulfide, (PPS), polyphthalamide, (PTA), poly-p-phenylene terephthalamide, polypropylene, (PP), polysiloxanes such as polydimethyl siloxane, polysulfides, polysulfone, (PSU), polytetrafluoroethylene, polyurethane, (PU), polyvinyl acetate, polyvinylchloride, (PVC), polyvinylidene chloride, (PVDC), polyvinylidene fluoride and polyvinyl fluoride, rayon, reinforced polyethylene terephthalate resins, segmented polyurethane elastomers, silicone resins, styrene butadiene block polymers, thermoplastic polyurethane elastomers, unsaturated polyester resins, urethane resins, vinyl chloride resins, vinyl polymers, vinylidene chloride resins and mixtures thereof.

In another embodiment, the polymeric substrate is a thermoplastic material. In another embodiment, the polymeric substrate is a thermoplastic material selected from the group consisting of thermoplastic polyolefins, alloys of polycarbonate and acrylonitrile-butadiene-styrene copolymers, alloys of polycarbonate and polyethylene terephthalate, alloys of polyamide and polyphenylene oxide, alloys of polyamide and polypropylene, alloys of polycarbonate and polyethylene terephthalate, alloys of polycarbonate and polybutylene terephthalate, polyamides, acrylonitrile-butadiene-styrene copolymers, acrylonitrile-butadiene-styrene homopolymers, polystyrene, high impact polystyrene, polypropylene, and mixtures thereof.

Preferably, the polymeric substrate is one or more of the polymers selected from the group consisting of epoxies, fluorinated resins, polyamides, polyesters, rayon, silicone resins, synthetic and natural rubbers, urethanes and mixtures thereof.

In one embodiment, the coating on the substrate is a paint coating. In another embodiment, the coating is paint coating overlaying the polymeric substrate is selected from the group consisting of polyester or polyacrylate cross-linked with polyurethane, and polyester/polyacrylate copolymers cross-linked with melamine formaldehyde; and the polymeric substrate is selected from the group consisting of thermoplastic polyolefins, alloys of polycarbonate and acrylonitrile-butadiene-styrene copolymers, alloys of polycarbonate and polyethylene terephthalate, alloys of polyamide and polyphenylene oxide, alloys of polycarbonate and polyethylene terephthalate, alloys of polycarbonate and polybutylene terephthalate, polyamides, acrylonitrile-butadiene-styrene copolymers, acrylonitrile-butadiene-styrene homopolymers, polystyrene, high impact polystyrene, polypropylene and mixtures thereof.

The polymeric material may include any or all of the following materials which are listed by way of example only, and not meant to be inclusive of plastic materials which can be recycled according to the present process. Such plastic materials include: ABS, polyacetal, acrylic, ionomer, polyamide in general, Nylon 6, Nylon 6/6, Nylon 6/9, Nylon 6/10, Nylon 6/12, Nylon 11, Nylon 12, polycarbonate, polyester (PBT), polyester (PET), polyether etherketone, polyethylene, polyolefin in general, polyphenylene ether, polyphenylene sulfide, polypropylene, polystyrene, polysulfone, polyurethane, SAN and thermoplastic elastomer. While the present invention may be useful with some of the commodity thermoplastics, such as low density polyethylene, polypropylene homopolymer, crystal polystyrene, rigid polyvinyl chloride, and the like, and more of the intermediate thermoplastics, such as polymethyl methacrylate, acrylonitrile-butadiene-styrene, acrylonitrile/acrylate/styrene, acrylonitrile/ethylene-propylene(EPDM)/styrene, styrene/maleic anhydride copolymers and rubber blends, cellulose-acetate-butyral, thermoplastic olefin elastomer, and the like, it is directed also toward the recycle of the engineering plastics. Examples of such engineering plastics include polycarbonate, polyphenylene ether, many of the polyesters and polyester blends, polyamides, acetal polymers and copolymers, thermoplastic polyurethanes, and the like. The present invention is also useful with some of the high performance polymers, such as glass filled polyphenylene sulfide, glass filled liquid-crystal polymer, polyetheretherketone, and polyethersulfone.

These plastics and blends of these plastics to be recycled by our invention may be modified with various additives including ultraviolet absorbers, antioxidants, pigments, fiber glass, carbon fibers, ceramic fibers, various minerals, rubber dispersions, for particular purposes such as increased tensile strength, increased impact strength, increased modulus, increased adhesion, improved aging characteristics, etc.

The preferred embodiments are exemplified by the following nonlimiting examples.

### EXAMPLES

### Example 1

### A Two Component, Immersion Paint Stripping System for Ferrous Metals

A two component system may be utilized to remove cured and uncured paint from ferrous substrates at elevated temperatures. This system is formulated to protect the treated steel parts from corrosion associated with stripping. The formulation for cured and uncured paint is shown in Table 4

TABLE 4

| Application | Un-Cured Paint | Cured Paint |
|---|---|---|
| ACTOSTRIP 500 HS | 10% to 30% by vol. H20 | 40% to 60% |
| | | by vol. |
| ACTOSTRIP 505 HSA | 5% to 20%/by vol. 500 HS | 10% to 30% |
| | | by vol. 500HS |
| Free Alkali Titration | 6 ml to 18 ml | 15 ml to 45 ml |
| Time (hrs) | 30 to 60 minutes | 1 to 2 hours |
| Temperature | 150 F. to 220 F. | 180 F. to 225 F. |

Make-Up: For desired stripping level, add appropriate amount of water to treatment vessel. Next, add ACTOSTRIP 500 HS followed by ACTOSTRIP 505 HSA (505 HSA is the organic medium added as the supernatant layer on top). The process solution will be 2 phase with the 500 HS and water on the bottom and the 505 HSA on top. It is preferred not to remove the top layer since this may effect performance of the stripping system.

Processing. Heat tank to desired temperature. Completely immerse parts to be stripped into stripping solution. Remove stripped parts and rinse w/H₂O using either immersion or spray process.

Maintenance. To maintain stripping efficiency, it is necessary to add ACTOSTRIP 500 HS and 505 HSA to the bath, as the concentrations are consumed by the stripping action. Refer to control section for instructions for chemical additions.

Free Alkali: Using sampling syringe, remove testing sample from below the top (505 HSA) phase. Using pipet, measure 5 ml of sample into beaker. Add 5 drops phenolphthalein, which will turn the sample pink. Titrate using 1.0 N of HCl solution until pink is gone. Note milliliters of 1 N HCl consumed.

Below is a table of approximate Free Alkali Titration vs. Volume % ACTOSTRIP 505 HS:

| ACTOSTRIP 500 HS (Vol. %) | Free Alkali Titration (ml) |
|---|---|
| 10 | 5 |
| 20 | 9 |
| 30 | 14 |
| 40 | 18 |
| 50 | 23 |
| 60 | 27 |
| 70 | 32 |
| 80 | 36 |
| 90 | 41 |
| 100 | 45 |

Bath Adjustment. To increase titration one milliliter (ml), add 2 gal. (25 lbs.) ACTOSTRIP 500 HS for every 100 gallons of bath volume. In general, each time an addition of ACTOSTRIP 500 HS is made to the tank, ACTOSTRIP 500 HSA should be added at the ratio of the make-up concentration.

Bath Life. As the stripping solution becomes saturated with paint, the effectiveness will decrease. Bath should be dumped and recharged when stripping time increases 50% over that of a new bath at the same titration and temperature.

Safety. Actostrip 500 is a corrosive material. The stripping solution is highly alkaline and can cause severe burns to exposed skin and eyes. Refer to the Material Safety Data Sheet for information on proper handling and personal protective equipment.

Generally, the alkaline content is variable and water is added at the point of use. The bath water content can vary dependent on end application as determined in advance by conducting pilot trial for prior to use. The titration for “free alkalinity” conveys inversely the total dissolved solids in the bath.

In use, the phrase “ACTOSTRIP 505 HSA 5% to 20%/by vol. 500 HS”, means including water, since the total aqueous layer will include any dilution made on site. In some cases, we have found that the 500 used neat is preferable (45% TDS) and in lesser applications we can dilute the aqueous layer down to approximately 20% TDS.

In this example, the technique used to measure TDS is a titration of the aqueous lower layer. In practice the TDS may be tracked over time to determine when to discharge a bath to waste disposal based on TDS. In this example, we first calculate total alkalinity with a titration of HCL with phenylthalien indicator to neutral. Then we back titrate with Bromophenyl blue indicator, the difference of the total dissolved alkalinity will tell us the relative “salt” and inorganic TDS from the paint removed in excess of the TDS contributed by the 500 itself. We know that when total TDS reaches 75%, then relative activities with respect to the system can no longer work.

Formulations.

For Ferrous metals:

500 HS (Typical Dilution 3 Parts to 1-3 Parts Water)

| | |
|---|---|
| Water | 0.156 |
| Sodium Metasilicate | 0.025 |
| (pentahydrate) | |
| Sodium Gluconate | 0.038 |
| KOH 45% solution | 0.781 |

505 HSA

| | |
|---|---|
| Glycol Ether EPH | 0.382 |
| Glycol Ether DPM | 0.293 |
| Neodol 25-3 | 0.096 |
| Triethanloamine | 0.05 |
| Surfynol SE-F | 0.01 |
| Neodol 91-2.5 | 0.094 |
| Triton CF-10 | 0.02 |
| Neodol 91-8 | 0.05 |
| Steol CS 460 | 0.005 |

For Polymeric Substrates:

501 HS (Typical Dilution 3 Parts to 1 Part Water)

| | |
|---|---|
| Water | 0.166 |
| Sodium Metasilicate | 0.015 |
| (pentahydrate) | |
| Sodium Gluconate | 0.048 |
| KOH 45% solution | 0.771 |

506 HAS

| | |
|---|---|
| Glycol Ether EPH | 0.380 |
| Glycol Ether DPM | 0.293 |
| Neodol 25-3 | 0.096 |
| Triethanloamine | 0.04 |
| Surfynol SE-F | 0.03 |
| Neodol 91-2.5 | 0.104 |
| Triton CF-10 | 0.01 |
| Neodol 91-6 | 0.05 |
| Alkali Surfactant | 0.005 |
| Cedaphos | 0.01 |

The surfactants are listed below

| | |
|---|---|
| Cedaphos | Phosphate Ester |
| Surfynol SE-F | Ethoxylated diol (super wetter) |
| Tomadol/Neodol 91-2.5 | Linear ethoxylated alcohol C9-C11 with |
| | avg moiety of 2.5 EO |
| Tomadol/Neodol 91-6 | Linear ethoxylated alcohol C9-C11 with |
| | avg moiety of 6 EO |
| Tomadol/Neodol 91-8 | Linear ethoxylated alcohol C9-C11 with |
| | avg moiety of 8 EO |
| Triton CF-10 | Modified Alkylarl Polyether |
| Alkali surfacatant | R-propionic acid monosodium salt |
| STEOL CS-460 | Sulphate of C12-C15 linear alcohol with |
| | avg. moiety of 3 EO |

Performance with the system at 100° C. is approximately 30 minutes per cross-linked paint layer.

The description fully satisfies the objects, aspects and advantages set forth. While the invention has been set forth in conjunction with specific embodiments thereof, it is evident that many alternatives, modifications, and variations will be apparent to those skilled in the art in the light of the foregoing description. Accordingly, it is intended to embrace all such alternatives, modifications, and variations which fall within the spirit and scope of the following claims.

We claim:

1. A composition substantially free of chlorinated solvents for the removal of cured and uncured paints and coatings from a substrated wherein the composition comprises (a) surfactants, (b) a sequestrant, and (c) a plasticizer/solvent.

2. The composition of claim 1 further comprising (d) a hydrolyzing agent present in an amount sufficient to reduce at least one of mechanical strength and adhesion between the coating and the substrate.

3. The composition of claim 2, wherein the hydrolyzing agent is a strong base selected from the group consisting of sodium hydroxide, potassium hydroxide, trisodium phosphate, disodium phosphate, and mixtures thereof.

4. The composition of claim 3, wherein the concentration of hydrolyzing agent is between about 1% and about 50% by weight.

5. The composition of claim 1, wherein the composition comprises:
a. from about 1 to about 45 wt. % (at final bath concentration) of a surfactant;
b. from about 1 to 15 wt. % of a solvent; and
c. from about 1 to about 98 wt. % of an alkalinity source.

6. The composition of claim 5, wherein the composition further comprises one or more compositions selected from the group comprising:
d. from about 1 to about 10 wt. % of a sequestrant;
e. from about 0 to about 15 wt. % of an alcohol;
f. from about 1 to 15 wt. % of a water-soluble plasticizer;
g. from about 0 to about 5 wt. % of a re-deposition inhibitor; and
h. other additives

7. The composition of claim 1, wherein the composition comprises:
a. from about 1 to about 45 wt. % (at final bath concentration) of a stripping agent;
b. from about 1 to 15 wt. % of a solvent; and
c. from about 1 to about 95 wt. % of an alkalinity source.
wherein the stripping agent comprises a surfactant, a sequestrant, an alcohol, a water-soluble plasticizer, a re-deposition inhibitor, an alkalinity source and mixtures thereof;
and wherein the surfactant comprises three surfactants A:B:C in a ratio of about 1:5:3, for penetrating wetters/particle formers:soft particle adsorbers metallic surface adsorbers.

8. The composition of claim 7, wherein the surfactant is selected from the group consisting of alcohol ethoxylates (linear and branched), nonylphenols, betaines, phosphate esters, alpha-olefin sulfonates, sulfates of alcohol ethoylates, sodium and ammonium lauryl sulphates, imadazolines, polyglycosides and various alcohols or is selected from C6 to C15 ethoxylated alcohols with an ethoxylation with 2 to 4 moles of ethylene oxide per R—OH].

9. The composition of claim 8, wherein the plasticizer has a boiling point of at least about 100 to about 250° C., is capable of “swelling” and plasticizing cured coatings; and is selected from the group consisting of glycol, glycol ether, high boiling point ketone (e.g., di-acetone alcohol) or long-chain alcohol (from about C1 to about C15 alcohol).

10. The composition of claim 1, wherein the composition comprises:
a. from about 1 to about 30 wt. % (at final bath concentration) of a surfactant;
b. from about 1 to about 20 wt. % of a sequestrant; and
c. from about 1 to about 15 wt. % of a water-soluble plasticizer;

11. The composition of claim 10, wherein the composition further comprises (d) from about 1 to about 95 wt. % of a hydrolyzing agent.

12. The composition of claim 11, wherein the composition further comprises from about 2 to about 5 wt. % of an alcohol.

13. The composition of claim 12, wherein the composition further comprises from about 1 to about 2.5 wt. % of a re-deposition inhibitor.

14. The composition of claim 7, wherein the surfactant comprises:
1. Surfactant A comprising one or more surfactants selected from the group consisting of Low Moiety EO nonionics, ethoxylated diols types, phosphate esters and R-propionic acid monosodium salts
2. Surfactant B comprising one or more surfactants selected from the group consisting of nionics and nonionics as a co-surfactant.
3. Surfactant C comprising one or more surfactants selected from the group consisting of Amphoterics, ethoxylated diols types and High Moiety EO Nonionics.

15. The composition of claim 14, wherein the composition comprises:
a. from about 2.5 to about 15 wt. % (at final bath concentration) of a surfactant;
b. from about 1 to about 2 wt. % of a sequestrant;
c. from about 5 to 7 wt. % of a water-soluble plasticizer; and
d. from about 1 to about 2.5 wt. % of a re-deposition inhibitor.

16. The composition of claim 15, wherein the composition further comprises (d) from about 1 to about 95 wt. % of a hydrolyzing agent

17. The composition of claim 16, wherein the composition further comprises from about 1 to about 15 wt. % of an alcohol.

18. The composition of claim 1, wherein the composition comprises:
a. from about 2.5 to about 15 wt. % (at final bath concentration) of a surfactant;
b. from about 1 to about 30 wt. % of a sequestrant;
c. from about 2 to about 25 wt. % of an alcohol;
d. from about 5 to 1 wt. % of a water-soluble plasticizer; and
e. from about 1 to about 5 wt. % of a re-deposition inhibitor.

19. The composition of claim 1, wherein the composition comprises:
a. from about 2 to about 45 wt. % (at final bath concentration) of a surfactant;
b. from about 1 to about 2 wt. % of a sequestrant;
c. from about 2 to about 5 wt. % of an alcohol;
d. from about 5 to about 15 wt. % of a water-soluble plasticizer;
e. from about 1 to about 5 wt. % of a re-deposition inhibitor; and
f. from about 1 to about 95 wt. % of an alkalinity source.

20. A method for removing paint or a coating from a substrate comprising applying a paint or coating removing effective amount of a composition comprising one or more of the compositions of claims 1-19 to the substrate.

21. A method for cleaning a substrate comprising applying a cleaning effective amount of a composition comprising one or more of the compositions of claims 1-19 to the substrate.

22. In one embodiment, the present invention provides for methods for removing paint based on specific innovations.

23. The method of claim 20 wherein the method provides for an immersion method for the removal of cured and uncured paint and coatings from ferrous metals.

24. The method of claim 20 wherein the method provides for an immersion method for the removal of cured and uncured paints and coatings from non-ferrous metals and light alloys.

25. The method of claim 20 wherein the method invention provides for an immersion method for the removal of cured paints and coatings from polymeric substrates.

26. The method of claim 20 wherein the surfactants utilized are alkaline stable at a pH greater than about 10 at elevated temperatures up to about 110° C. or more.

25. The method of claim 20 wherein the immersion times are in excess of about 20 to 120 minutes.
